(19) United States
(12) Patent Application Publication
(10) Pub. No.: US 2025/0345664 A1
(43) Pub. Date: Nov. 13, 2025

(54) OPTICAL TRACKING SYSTEM

(71) Applicant: Wilson Sporting Goods Co., Chicago, IL (US)

(72) Inventors: Kevin L. Krysiak, Palatine, IL (US); John P. Davern, Chicago, IL (US); Alan B. Lebowitz, Asheville, NC (US); Chin-Hung Chu, Taichung City (TW)

(73) Assignee: Wilson Sporting Goods Co., Chicago, IL (US)

(21) Appl. No.: 19/204,460

(22) Filed: May 9, 2025

Related U.S. Application Data
(60) Provisional application No. 63/644,689, filed on May 9, 2024.

(51) Int. Cl. A63B 43/06; A63B 41/08; G01S 7/51; G01S 17/66

(52) U.S. Cl. CPC A63B 43/06; A63B 41/08; G01S 7/51; G01S 17/66; A63B 2225/12

(57) ABSTRACT

A game ball for an optical tracking system includes a tracked region on the game ball. The tracked region includes a retro reflective surface and an optical filter overlying the retro reflective surface.

### APPLICATIONS

The present application claims benefit from co-pending U.S. Provisional Patent Application Ser. No. 63/644,689, filed on May 9, 2024, by Krysiak et al. and entitled OPTICAL GAME BALL TRACKING, the full disclosure of which is hereby incorporated by reference.

### BACKGROUND

Most sports employ a game ball such as a basketball, a volleyball, a soccer ball, an American football, and the like. Tracking movement, such as spin, location and speed, of the game ball may be very useful for player training and evaluation, fan engagement, gambling and the officiating assistance. However, modifying such game balls to facilitate tracking, without detrimentally impacting the appearance or performance characteristics of the game ball, or the player experience, is often challenging.

### BRIEF DESCRIPTION OF THE DRAWINGS

FIG. 1 is a diagram schematically illustrating portions of an example tracking system.

FIG. 2 is a flow diagram of an example method for being carried out by the tracking system of FIG. 1.

FIG. 3 is a perspective view of an example game ball with example tracked regions.

FIG. 4 is a perspective view illustrating example panels of the game ball of FIG. 3.

FIG. 5 is a section view of a portion of the example game ball of FIG. 3 taken along line 5-5.

FIG. 6 is a diagram illustrating a display of the system of FIG. 1 presenting travel parameters and an image of the game ball of FIG. 3 with an image superimposed on the tracked region.

FIG. 7A is a graph depicting light absorption by different implementations of the tracked region for different wavelengths of light.

FIG. 7B is a bar graph depicting L*a*b* values for different implementations of the tracked region relative to an untracked region.

FIG. 7C is a line graph depicting L*a*b* values for different implementations of the tracked region relative to an untracked region.

FIG. 8 is a diagram illustrating light spectrums for different wavelengths.

FIG. 9 is a sectional view of an example game ball taken along line 5-5 of FIG. 3.

FIG. 10 is a sectional view of an example game ball taken along line 5-5 of FIG. 3.

FIG. 11A is a line graph depicting absorption properties for an example diluted staining dye for different wavelengths.

FIG. 11B is a line graph depicting L*a*b* values for a tracked region (panel 8) with one coat of the staining dye of FIG. 11A relative to untracked regions (panels 1-7).

FIG. 11C is a line graph depicting L*a*b* values for different implementations of a tracked region (different numbers of coats of the staining dye of FIG. 11A) relative to untracked regions (leather).

FIG. 12 is a sectional view of an example game ball taken along line 5-5 of FIG. 3.

FIG. 13 is a sectional view of an example game ball taken along line 5-5 of FIG. 3.

FIG. 14 is a perspective view of an example game ball having example tracked regions.

FIG. 15 is a diagram illustrating a display of the system of FIG. 1 presenting an image of the game ball of FIG. 14 with travel parameters and images superimposed on the tracked regions.

FIG. 16 is a perspective view of an example game ball having example tracked regions.

FIG. 17 is a diagram illustrating a display of the system of FIG. 1 presenting travel parameters and an image of the game ball of FIG. 16 with images superimposed on a tracked region.

FIG. 18 is a perspective view of an example game ball having an example tracked regions.

FIG. 19 is a perspective view of an example game ball having example tracked region.

FIG. 20 is a diagram illustrating a display of the system of FIG. 1 presenting an image of the game ball of FIG. 19 with images superimposed on a tracked region.

FIG. 21 is a perspective view of an example game ball having example tracked regions.

FIG. 22 is a diagram illustrating a display of the system of FIG. 1 presenting travel parameters and an image of the game ball of FIG. 21 with images superimposed on the tracked regions.

FIG. 23 is a perspective view of an example tennis racket having example tracked regions.

FIG. 24 is a diagram illustrating a display of the system of FIG. 1 presenting an image of the example tennis racket of FIG. 23 with travel parameters and images superimposed on the tracked regions.

FIG. 25 is a perspective view of an example pickle ball paddle/racket having example tracked regions.

FIG. 26 is a diagram illustrating a display of the system of FIG. 1 presenting travel parameters and an image of the pickle ball/racket of FIG. 25 with images superimposed on the tracked regions.

FIG. 27 is a perspective view of an example ball bat having an example tracked region.

FIG. 28 is a diagram illustrating a display of the system of FIG. 1 presenting travel parameters and an image of the ball bat of FIG. 27 with images superimposed on the tracked region (bat and helmet).

FIG. 29 is an enlarged view of a portion of the display shown in FIG. 28.

FIG. 30 is a diagram schematically illustrating portions of an example tracking system comprising an example game ball.

FIG. 31 is a line graph illustrating reflection properties for different implementations of the tracked region game ball of FIG. 30.

FIG. 32 is a perspective view of an example game ball for use with the example system of FIG. 30.

FIG. 33 is a sectional view of a portion of the game ball FIG. 32 taken along line 33-33.

FIG. 34 is a diagram illustrating a display of the system of FIG. 30 presenting travel parameters and an image of the game ball of FIG. 32 with images superimposed on the tracked region.

FIG. 35 is a sectional view illustrating portions of an example game ball having tracked regions.

FIG. 36 is a perspective view illustrating portions of an example game ball having tracked regions within channels of the game ball.

FIG. 37 is an enlarged fragmentary sectional view of the tracked regions of FIG. 36.

FIG. 38 is a sectional view of an example tracked region for the example game ball of FIG. 36.

FIG. 39 is a perspective view of an example game ball for use with the system of FIG. 30.

FIG. 40 is a sectional view of the game ball FIG. 39 taken along line 41-41.

FIGS. 41A, 41B and 41C are sectional views illustrating an example method for forming a retroreflective layer for the tracked region for the game ball of FIG. 39.

FIG. 42 is a diagram validating a display of the system of FIG. 30 presenting travel parameters and an image of the game ball of FIG. 39.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example game balls, tracking systems, and methods for forming game balls that facilitate tracking the spin, location and/or speed of the game ball during play with a reduced impact on the performance characteristics of the game ball and with reduced or controllable visibility to players and fans. The example game balls facilitate optical tracking of the game balls.

In some implementations, the example game balls facilitate tracking of the game balls using a “tracked region”) applied to the game ball. The tracked region optically highlights selected portion of the game ball for enhanced tracking. The tracked region may be printed upon the ball, painted upon the ball, applied as a film to a surface of the game ball or blended/mixed in a structural material of the game ball.

The optically highlighted tracked region provides enhanced camera perceptible contrast for tracking a game ball. For example, tracking a traditional National Basketball Association (NBA) basketball without such a tracked region may be difficult. The current contrast between the channels and panels of an existing or traditional NBA basketball may be insufficient for tracking or discernment by an arena camera or other camera since the brown leather and black channels are relatively close in pantone color. The logos on the NBA leather may also be hard for a camera to pick up. In addition, the pantones of the NBA ball can be found elsewhere in the environment (jerseys, court, players, etc.) which adds to the challenge. In contrast, the optically highlighted tracked region or regions of the present disclosure may create a camera perceivable stark contrast.

In some implementations, the tracked region is detectable by a visible spectrum camera with sufficient, extraordinary lighting, but is largely undetectable to the naked eye or to the naked eye without extraordinary levels of visible light or white light being directed at the game ball. One example of “extraordinary” of visible light may be directed to game ball may be that of a flash from a camera or overhead lighting in a sports arena. In such circumstances, the players and fans may have a lower degree of visual recognition, discernment or appreciation of the marker/tracked region as compared to that of a camera provided with such extraordinary lighting. The player level lighting, absent a flash, is insufficient for greater than de minimis visual recognition, discernment or appreciation of the mark by the players or fans.

In some implementations, the marker or coating, serving as the tracked region, may comprise at least two layers, a retro reflective layer covered by a filter layer configured to transmit a predetermined range of wavelengths of incident radiation or light and absorb those incident wavelengths of light outside the range. Examples of such a filter layer include a band pass filter layer and a wavelength spectrum cut on filter layer. A retro reflective layer is a layer that provides a surface that reflects radiation (visible light) back to its source with minimum scattering. The retro reflective layer may be in the form of a coating, film, laminate or the like applied to the game ball.

The wavelength spectrum cut on filter comprises one or more layers that have a chemical composition, thickness and configuration such that the filter acts as a lens that absorbs incident light and inhibits reflection of light from the underlying retro reflective layer. The wavelength spectrum cut on filter may be in opaque material applied over the retro reflective marker or markers. In one implementation, the wavelength spectrum filter may comprise a visibly opaque dye that is a dark color, such as black, in visible light, but that which transmits near infrared wavelengths of light (a near infrared filter) or wavelengths of light in the infrared spectrum and extending into an upper region of the visible spectrum.

For purposes of this disclosure, the term “near infrared +” or “NIR+” may refer to wavelengths of light limited to the near infrared spectrum (780 nm or above), wavelengths of light limited to the near infrared and infrared spectrums” or wavelengths of light in the near infrared spectrum and extended into the upper regions or edge of the visible spectrum (less than 780 nm). A “wavelength range” refers to a particular portion of the electromagnetic radiation spectrum, wherein the wavelength range may refer to individual spectrum or may overlap the boundaries of adjacent spectra.

The cut on point, the point at which the amount of reflected light drastically increases may be at the edge of and include part of the visible light spectrum, less than 780 nm (an extended near infrared (NIR+) filter), wherein visible light below the cut on point is subdued or difficult to detect with the naked eye. In some implementations, the NIR+ filter may have a cut on point at a wavelength of at least 700 nm. In some implementations, the wavelength spectrum filter may have a cut on point at a wavelength of up to 780 nm or in the near infrared spectrum.

One example of such an NIR+ filter is a visibly opaque dye, paint or coating. In one implementation, the visibly opaque dye comprises a black, solvent-based screen-printing dye having the ability to absorb UV and visible light by allowing transmittance of infrared light. Such an dye properly thinned may serve as the NIR+ filter that is opaque or dark across a majority of the visible wavelength spectrum and which has a cut on point at a wavelength of at least 700 nm (within the upper end of the visible spectrum). One example of such a dye is Spectre 100 or 110 commercially available from Epolin, In such implementations, the dye may be applied with a sufficient number of coatings to a desired level of opaqueness and reflected-light transmissivity, depending upon the degree to which players and fan appreciation of the marker is undesired.

The location of the tracked region may also have an impact upon whether the marker/tracked region affects or impacts the appearance or performance of the game ball as well as whether the marker/tracked region will be appreciated by players or fans during play under normal, non-extraordinary lighting conditions. In some implementations, the game ball may comprise a basketball configured for sanctioned competitive play, high school, college (NCAA), professional (NBA) and the like. Such basketballs are to be provided with panels separated by channels. Such basketballs typically include panels and a valve region. Such basketballs are also provided with external markings or logos.

In some implementations, the marker serving as the tracked region and composed of the retro reflective layer and the overlying filter may be provided in selected portions of the channels or throughout such channels. Providing the marker in the channels recesses the marker from the main surface of the basketball contacted by the player and reduces the likelihood that the marker will impact the grip or touch of the basketball. Providing the marker in such channels may further render the markings more discreet to players and fans. As discussed above, in some implementations, the marker may be printed or coated within the channel. In other implementations, the marker may be in the form of a coated film or multilayer film that is applied to the floor of the channel.

In some implementations, the marker/tracked region may be in the form of a thin strip of the retro reflective coating or material and the overlying NIR+ cut on filter/Dye around or outlining a marking or logo on the basketball. In such implementations, the marking or logo may have a dark color that corresponds to the color of the NIR+ cut on filter dye. For example, logo may have a color black, wherein the NIR+ cut on filter is also black. The matching colors may further assist in rendering the marker less visible to the naked eye under normal lighting conditions.

In some implementations, the marker/tracked region may be provided in close proximity to the valve region or about the valve. In some implementations, the marker serving as a tracked region may be provided in close proximity or as an outline of a logo or other surface decoration on the game ball or other piece of sporting equipment. In some implementations, the marker serving as a tracked region may form the decoration or logo itself, rather than just an outline. Such locations may have a less impact on the aesthetics of the basketball, even if visually recognized by a player or fan, as the marker may assist in drawing attention away from the valve itself and the marker is in less conspicuous region of the basketball.

In implementations where the marker/tracked region is provided on the game ball in the form of a basketball, the marker may assist in tracking the trajectory, speed, spin and position of the basketball during play. The relative positioning of the basketball to players or to the basketball hoop may also be tracked. Such tracking may be carried out by optical cameras that may direct or be near sources of extraordinary light that enhance their pickup of the marker on the basketball, whereas player level or floor level viewing of the basketball is less subject to such extraordinary light and may not be visually ascertainable by the players or fans. In such implementations, a computer vision system may be provided with real-time images captured by the camera to track the basketball and acquire or derive data from such tracking. As noted above, such data may be beneficial for players training and evaluation, fan engagement, gambling and officiating/referee assistance. With respect to officiating assistance, tracking of the basketball may assist in identifying a last touch of the basketball before the basketball goes out of bounds or identification of goaltending during a shot of the basketball.

In some implementations, the marker or coating serving as a tracked region may comprise a NIR+ absorbing marker. Rather than transmitting light reflected from an underlying surface, such as a retro reflective surface blocking selective wavelengths of the reflected light to establish a cut on point, the mark or coating absorbs NIR+ wavelength of light. Such NIR+ absorbing markers may be dark or opaque and not ascertainable to the naked eye. When the game ball with the NIR+ absorbing marker is captured with an infrared camera, those regions with the marker, at least at certain wavelengths, appear darker. Tracking of the game ball may be achieved by a computer vision system identifying dark regions and the movement of such dark regions as captured by an infrared camera during motion of the game ball.

In some implementations, the NIR+ absorbing marker may be in the form of an NIR+ absorbing material blended into other materials that form a structural component of the game ball. For example, in some implementations the game ball may comprise a basketball formed from a composite material including polyurethane. The NIR+ absorbing material may be blended into the polyurethane.

In some implementations, the NIR+ absorbing marker may be in the form of an NIR+ absorbing material coated or sprayed onto an outer surface of the game ball. For example, in some implementations, the game ball may comprise a basketball formed from a natural or synthetic leather material, wherein the NIR+ absorbing material is sprayed or coated upon selected portions of the outer surface of the leather or synthetic leather material. In some implementations, the NIR+ absorbing material being sprayed or coated upon selected portions of the outer surface of the game ball stains the outer surface to facilitate optical tracking without substantially altering the feel or other performance characteristics associated with the outer surface of the game ball lacking the surface coating or staying.

In some implementations, the NIR+ absorbing marker may be in the form of material blended into a structural material of the game ball to provide different portions of the game ball with a different material composition. In some implementations, the NIR+ absorbing marker may be coated on a structural surface of the game ball. In some implementations, the NIR+ absorbing marker may be in the form of a film or laminate applied to the game ball. In some implementations, the NIR+ absorbing marker may itself be shaped so as to form a logo, graphic or other marking on the game ball. For example, in certain implementations, the NIR+ absorbing marker may be selectively printed in a pattern so as to form text, graphics or other markings that serve as virtual advertising on the game ball.

In implementations where the game ball comprises a basketball, the NIR+ absorbing marker may be blended into the material used to form the floors of the channels of the basketball. In other implementations, the NIR+ absorbing marker may be thinly applied across those surfaces of the basketball, given that the NIR+ absorbing surface may be provided with a color that closely matches the leather pantone of some basketballs.

In some implementations, the game ball may be formed from distinct panels, wherein consecutive panels have different NIR+ absorption characteristics to provide optical contrast between such panels in camera captured images (with extraordinary lighting). The optical contrast may facilitate tracking of the game ball and the determination of a rotational orientation of the game ball (spin). In some implementations, a first one of the consecutive panels may omit any NIR+ absorbing film, stain or material composition and a second one of the consecutive panels may include an NIR+ absorbing film, stain or material composition.

In some implementations, both of the first and second consecutive panels may include an NIR+ absorbing film, stain or material composition, but where the panels have different types of NIR+ absorbing films, stains or material compositions. In some implementations, the consecutive panels may both include the same type of NIR+ absorbing film, stain or material composition, but where the consecutive panels have different relative degrees of loading (thickness of a coating, film or stain, density or concentration of NIR+ materials). Because the consecutive panels have the same type of NIR+ absorbing film, stain or material composition, but just different relative material densities, thicknesses or concentrations, the relative feel or performance characteristics of the two consecutive panels may be less perceptible to a person using the game ball, but sufficiently distinct to provide adequate camera captured image contrast for ball tracking.

In some implementations, the regions of the game ball provided with the NIR+ absorbing film, stain or material composition may be used by the computer vision system to identify a region or location on the game ball onto which a graphic is to be virtually imposed for a video presentation, such as a live broadcast, instant replay, a recorded replay, or selected video clips. The graphic may be in the form of, and image, text of the like virtually imposed by the computer vision system or other image processing systems. For example, during a broadcast of a sport involving the game ball, a graphic, image, text of the like may be virtually imposed upon those portions of the game ball provided with the NIR+ absorbing film, stain or material composition such that the graphic, image, text or the like is viewable by persons watching the broadcast (image frames) (live or recorded/delayed) of the competition, wherein the graphic, image, text of the like is not viewable by persons watching the competition in person or live (absent a video presentation on a monitor, television or other display concurrently being presented at the live competition with the virtually imposed image). Examples of such virtually imposed graphics or images, but are not limited to, advertising or sponsor information, current movement or travel characteristics of the game ball (its current velocity, spin of the like), or other information pertaining to the competition (the current score, statistics, probabilities of a score or of a win, game time or remaining game time, remaining shot clock time, team last touch, gambling offers of date, or the like).

For example, the computer vision system may virtually impose a graphic, such as a color, text or other indicator which indicates the team that last touched the game ball in play. A replay may show movement of the game ball, wherein the virtually impose graphic changes color or other characteristics to indicate the last touch of the game ball by players of different teams. By way of a specific example, in a game of basketball, the virtually imposed graphic may change colors multiple times as a ball is deflected off of different players from different teams before finally landing out of bounds.

In some implementations, the marker may additionally or alternatively incorporate a lenticular effect. In particular, a lenticular surface or mechanism may be applied over the retro reflective surface or over the NIR+ cut on filter or dye which overlies the retro reflective surface. The lenticular surface or lenticular channels may impair ascertainment or recognition of the marker from certain viewing angles. In such implementations, various locations on a game ball may have different lenticular affect orientations to enhance tracking of the game ball. In some implementations, directional holographic films or stickers may be provided based upon the orientations of the lenticular coatings or structures.

In some implementations, the surface of the game ball may be provided with porosity or perforations, wherein the reflective markers (the retro reflective surface or the retro reflective surface covered by the NIR+ cut on filter) underlie the openings or perforations. In such implementations, providing the markers below such perforated surfaces may further assist in concealing the markers to the naked eye of the players or fans while the ball being tracked during play.

Although the game ball tracking markers or tracked regions are illustrated as being formed on or applied to basketballs, in other implementations, each of the ball tracking markers described above may likewise be incorporated into other game balls where tracking of the ball may be beneficial. Examples of such game balls include, but are not limited to, a volleyball, a soccer ball, an American style football, a baseball, a tennis ball and the like. In such game balls, the marker may be incorporated or provided in the seams or junctions of panels or may be provided in particular regions of the game ball such as where a portion of the game ball can have a darker color than portions of the game ball that are less conspicuous during play. For example, such markings may be provided at the base of the laces of an American football, in the laces themselves, in the dark padded regions of a soccer ball, along the seams of a soccer ball or volleyball or along the edges of the seams of a baseball or tennis ball. Such markers/track regions may be provided along or in any logos or markings on such game balls. In some implementations, the coatings that selectively absorb or selectively transmit particular wavelength ranges of light may be applied to the stringing of a racket.

In some implementations, the NIR+ markings/tracked regions may be provided on surfaces of sporting equipment. For example, the NIR+ markings may be provided on surfaces of a ball bat, on surfaces of the paddle or racket or the like. As discussed above, such NIR+ markings may be detected by a computer vision system, wherein the computer vision system utilizes detected markings to determine where a virtually imposed graphic, such as advertising or the like) is to be placed in a video presentation. In some implementations, the computer vision system may utilize NIR+ markings to identify a perimeter of a region, wherein the virtually imposed graphic is contained within the perimeter. In such a manner, the NIR+ markings need not necessarily cover the entire area or region upon which a virtually imposed graphic is to be imposed. The size or area of the virtually imposed graphic need not be limited by the continuous area of the NIR+ marking. For example, NIR+ marketing may be provided along the frame of a hoop of a tennis racket or other strung racket, wherein the virtually imposed image may be imposed within the hoop of the racket as defined by the NIR+ markings extending along the hoop of the racket.

For purposes of this disclosure, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the term “coupled” shall mean the joining of two members directly or indirectly to one another. Such joining may be stationary in nature or movable in nature. Such joining may be achieved with the two members, or the two members and any additional intermediate members, being integrally formed as a single unitary body with one another or with the two members or the two members and any additional intermediate member being attached to one another. Such joining may be permanent in nature or alternatively may be removable or releasable in nature.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this, unless explicitly recited to the contrary, recitations reciting that signals “indicate” a value or state means that such signals either directly indicate a value, measurement or state, or indirectly indicate a value, measurement or state. Signals that indirectly indicate a value, measure or state may serve as an input to an algorithm or calculation applied by a processing unit to output the value, measurement or state. In some circumstances, signals may indirectly indicate a value, measurement or state, wherein such signals, when serving as input along with other signals to an algorithm or calculation applied by the processing unit may result in the output or determination by the processing unit of the value, measurement or state.

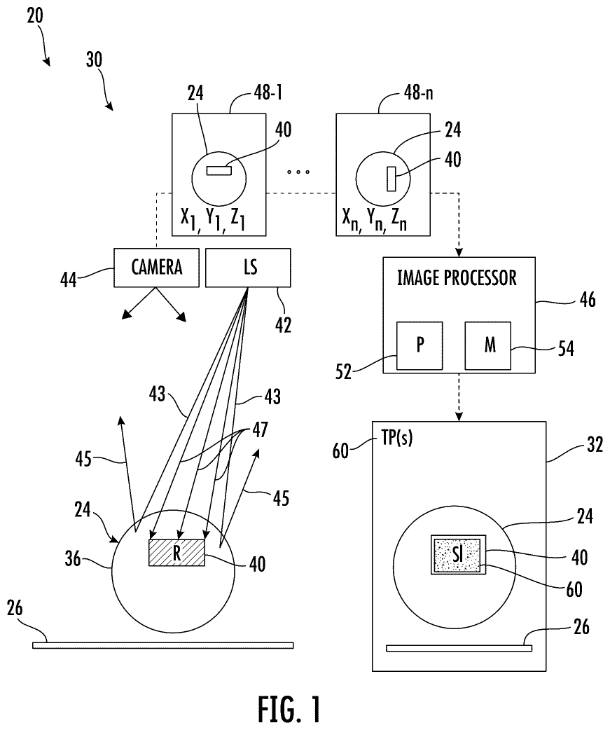

FIG. 1 is a diagram schematically illustrating portions of an example tracking system 20. Tracking system 20 is configured to optically track a moving sport object, such as a game ball, a paddle or racket, a ball bat or other sporting equipment based upon light (in the visible spectrum and/or outside the visible spectrum) absorbed and/or reflected from the sport object. The sport object is optically altered or enhanced to facilitate better tracking. For example, the sport object may be altered so as to include a particular tracked region or multiple tracked regions that have a level or degree of optical contrast with other regions or portions of the sport object such that the tracked regions are more easily distinguished by an image processing system for tracking movement of the tracked region. This contrast may be achieved optically, highlighting the tracked region for perception by a camera and image processing system. Such optical highlighting may be achieved by altering the absorption or reflection of a particular wavelength of light by the tracked region, wherein the absorption or reflection of the particular wavelength of light by the tracked region permits the location, shape and/or size of the tracked region to be discerned by an image processing system without the optical “highlighting” of the tracked region being perceptibly obvious to an untrained naked eye of a sport player or an observer/fan given the typical lighting conditions for the sporting competition or event.

In some implementations, tracking system 20 tracks the sport object so as to analyze and/or present or display information pertaining to movement characteristics or travel parameters of the sport object, such as spin direction, spin acceleration, spin speed, trajectory and the like. In some implementations, tracking system 20 may further draw and display or present conclusions based upon the travel parameters of sport object. For example, tracking system 20 may determine the last team or player to touch a game ball before the game ball goes out of bounds.

In some implementations, tracking system 20 may additionally or alternatively track movement of the sport object to identify a predefined surface or region of the sporting object upon which a virtual image may be superimposed on the particular region of the sport object as part of a video presentation, such as substantial real-time during a live broadcast, during an instant replay are as part of a video recording of a sporting event or video clips or highlights of the sporting event. In some implementations, the virtual image may be superimposed while the sport object is in motion. In some implementations, the virtual image may comprise advertising or sponsor information, current movement or travel characteristics of the game ball (its current velocity, spin of the like), or other information pertaining to the competition (the current score, statistics, probabilities of a score or of a win, game time or remaining game time, remaining shot clock time,, team last touch, or the like.

Tracking system 20 comprises a sporting object or sporting equipment, shown as an example game ball 24, computer vision system 30, and display 32. Although the game ball 24 is illustrated as being spherical (such as a basketball, volleyball or soccer ball), the game ball 24 may have other shapes, such as that of an American style football. As will described hereafter, in other implementations, the sporting object may have other forms of sporting equipment including but not limited to ball bats, rackets, paddles, helmets or other protective garments or apparel worn by a person participating in a sporting competition.

Game ball 24 comprises an outer surface 36 on or through which a tracked region 40 may be sensed or detected by computer vision system 30. Tracked region 40 is optically highlighted and optically distinguished from adjacent or nearby portions of game ball 24 so as to be discernible from such other adjacent or nearby portions of game ball 24 by computer vision system 30. Such optical highlighting is done in a manner such that although readily discernible to computer vision system 30, tracked region 40 is not perceptibly obvious or is largely indiscernible to the naked eye of the player or observer/fan. Region 40 is optically highlighted by its ability to absorb particular wavelengths of light differently than that of surrounding regions of game ball 24. Region 24 has a first NIR+ absorption characteristic while surrounding regions have a second NIR+ absorption characteristic different than the first NIR+ absorption characteristic. In the example illustrated, region 40 absorbs a greater amount of NIR+ light as compared to that of surrounding regions a game ball 24. In some implementations, region 40 has an absorption characteristic that drastically jumps or increases for wavelengths of 580 nm and above. In some implementations, region 40 has an absorption characteristic that drastically jumps or increases for wavelengths beginning at approximately 780 nm. As a result, region 40 reflects less light and appears darker in images captured by system 30 as compared to the surrounding regions of game ball 24.

Although schematically illustrated as a rectangle, region 40 may have a variety of other sizes and shapes. For example, in some implementations, region 40 may have an area having a perimeter corresponding to the perimeter of an individual panel of game ball 24 or corresponding to the perimeter or outline of a grouped set of adjacent panels of game ball 24. In some implementations, region 40 may have an area having a perimeter wholly contained within an individual panel of game ball 24. In some implementations, region 40 may extend across multiple panels, having an area having a perimeter that does not correspond to a perimeter of a panel, but passes through a central portion of a panel. In some implementations, region 40 may be provided along a junction of adjacent panels. In some implementations, region 40 may be discontinuous in that region 40 surrounds or extends about intermediate portions that are not optically enhanced, portions that may be similar to the other surrounding portions of game ball 24. For example, region 40 may be an annular shape, text, or open/perforate graphics/patterns, rather than a solid continuous unbroken and imperforate layer or area.

Computer vision system 30 comprises light source 42, camera 44 and image processor 46. Light source 42 directs light onto game ball 24 and its surrounding environment 26 (schematically illustrated by an underlying line). Light source 42 may direct “extraordinary” visible light towards the game ball, such as that of a flash from a camera or overhead lighting in a sports arena. In some implementations, light source 42 may comprise multiple light sources supported by an overhead catwalk near the ceiling of a sports arena. In some implementations, light source 42 may be incorporated as part of camera 44. In some implementations, light source 42 may be provided by a portable electronic device, such as a smart phone.

As schematically, light 43 from light source 42 impinges the outer surface 36 of game ball 24. Those portions 47 of light 43 impinging region 40 are more greatly absorbed by region 40. As described above, region 40 absorbs light in the NIR+ portion of the spectrum and upper portions of the visible wavelength spectrum. Those portions 45 of light 43 impinging the outer surface 36 of game ball 24 about region 40 are absorbed to a lesser extent. In particular, the same NIR+ portion of the spectrum and upper portions of the visible wavelength spectrum that impinge portions about region 40 are reflected from or in a direction away from surface 36. This results in the image frames 48 captured by camera 44 having darkened regions corresponding to region 40.

Camera 44 has a field-of-view encompassing game ball 24 and the surrounding environment 26. The field of view of camera 44 may be sufficiently large to capture movement of game ball 24. In some implementations, camera 44 comprises a camera that captures light in the visible spectrum (300 nm to approximately 780 nm). In some implementations, camera 44 may be additionally configured to capture light beyond the visible spectrum, in the NIR+ (NIR+) spectrum (780 nm to 2500 nm) or the infrared spectrum (greater than 2500 nm). In some implementations, camera 44 comprises a two-dimensional camera. In other implementations, camera 44 comprises a stereoscopic camera. In some implementations, the output of camera 44 may additionally be in the form of a point cloud. Camera 44 may be in the form of a video camera capturing multiple frames 48-1 . . . 48-n which are communicated to image processor 46.

As schematically illustrated, each of frames 48-1 . . . 48-n may depict game ball 24 at a particular location, with a particular set of coordinates x, y, z. Movement or rotation of game ball 24 also results in movement or rotation region 40, which appears as a darkened region in each of image frames 48 due to the greater degree of absorption of NIR+ light (and a small portion of visible light) by region 40. Each of such frames 48 is streamed to image processor 46.

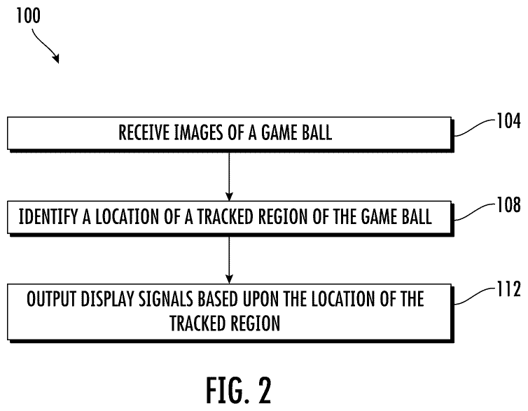

Image processor 46 analyzes image frames 48 received from camera 44. Image processor 46 comprises processing unit 52 and memory 54. Processing unit 52 is part of a processing resource configured to carry out analysis and output control signals following instructions contained in memory 54. Memory 54 comprises a non-transitory computer-readable medium storing such instructions. The instructions in medium 54 direct processing unit 52 to carry out the example method 100 outlined in FIG. 2.

As indicated by block 104 in FIG. 2, image processor 46 receives images/frames 48 of game ball 24 from camera 44. As discussed above, the depictions of game ball 24 in images 48 include darkened regions corresponding to region 40. As indicated by block 108, the instructions contained in memory 54 direct processing unit 52 to identify a location of the tracked region 40 of the game ball 24 in each or some of the image frames 48. The location may comprise attributes such as a centroid of the tracked region 40, a perimeter of the tracked region 40, and/or the x, y, z coordinates of the tracked region in a particular coordinate system. Image processor 46 may identify the location of the tracked region 40 by analyzing, on a pixel-by-pixel basis, the darkness of individual pixels as compared to the darkness of adjacent pixels. The boundaries between adjacent or consecutive pixels having the greatest delta or difference in darkness may be identified as the boundary/perimeter of the tracked region 40 in the image frame. Based on the determined boundary of 40, a centroid of region 40 or other reference point for region 40 may be determined. In other implementations, image processor 46 may determine or identify the location of the game ball 24 in each of the image frames 48 using other image processing or segmentation techniques. For example, in some implementations, machine learning (a trained machine learning or neural network) by image processor 46 to identify the boundary or perimeter of each of the tracked regions 40 on game ball 24 in each of frames 48.

In some implementations, the x,y,z coordinates of the tracked region 40 (or a centroid or other point of the tracked region 40) may be determined by image processor 46 based upon the predetermined or known real-world geographical x,y,z coordinates of camera 44 and its field-of-view (and the relative positioning of game ball 24 within the field-of-view). Use of a point cloud by a stereoscopic camera may assist with the determination of such coordinates. In some implementations, image processor 46 may determine coordinates that are in terms of relative positioning to the environment, such as relative positioning of the region 40 (or of ball 24) to a particular point or location in the environment 26, on a playing field, court, target (basketball hoop/backboard) or the like, with or without reference to real-world geographical coordinates. Such coordinates may be determined based upon a known or predetermined relative positioning of the camera 44 with respect to such points or locations in the environment 26 or based upon images of the environment 26 in the frames 48 received by image processor 46. For example, the environment 26 may include optical markers indicating particular coordinates or locations, or an image processor 46 may determine the particular coordinates of game ball 24 in each image frame based upon the environmental markers also found in the image frame.

As indicated by block 112 in FIG. 2, the instructions in memory 54 direct processing unit 52 to output display signals that are based upon the identified location of the tracked region, that are based upon at least one of the real-world geographic coordinates of a centroid, movement of the location tracked region during different captured image frames, relative positioning of region 40 or its reference points (centroid, corners, perimeter outline) with respect to the environment (field, court, target). This display signals cause display 32 to present an image or video depicting game ball 24 and the current environment 26 with one or more travel parameters TP(s) 60 and/or a superimposed image 64.

Examples of travel parameters 60 include, but are not limited to, the trajectory, speed, spin direction, spin speed, spin acceleration and position of the game ball during play. Image processor 46 may determine the trajectory of game ball 24 by determining the change in the coordinates of the tracked region 40 between particular image frame 48. Image processor 46 may determine the speed at which game ball 24 is traveling based upon the changing coordinates and the amount of time consumed during such travel. Image processor 46 may determine the spin speed by determining changes in the angular positioning of the tracked region 40 over a predetermined amount of time up to the current image frame 48 being presented on display 32 or being recorded. Likewise, spin acceleration may be determined as well. Image processor 46 may determine the position of the game ball in the current image frame being presented on display 32 or being recorded based upon the determined real-world geographical coordinates of the game ball and/or coordinates of the game ball relative to markers or other locations in the environment 26.

Such travel parameters may also include analysis based upon movement of the game ball. For example, image processor 46 may analyze the determined directional spin of the game ball or changes in such directional spin to determine if a particular player was last to touch the game ball before the game ball traveled out of bounds. The travel parameters 60 may indicate which team or which player was last to touch the game ball. Image processor 46 may likewise determine a probability or likelihood of the ball hitting the target during flight, wherein this probability may be presented. In some implementations, the positioning of region 40 may be utilized to determine what part of the game ball was last touched by a player. Such information may be utilized for player performance analysis and gambling. In some implementations, travel parameters 60 may be part of the presentation presented on display 32 with game ball 24. In yet other implementations, the travel parameters 60 may be presented on a display without any depiction of game ball 24 or environment 26.

Superimposed image 64 comprises alphanumeric text, graphics, logos or combinations thereof providing information to a viewer. In some implementations, image 64 may comprise a logo, advertising or sponsor information. In some implementations, image 64 may comprise any of the above-mentioned travel parameters. For example, image 64 may comprise the current rotational speed/spin, spin acceleration, trajectory or positioning or coordinates of game ball 24. Image 64 may present a determined statistic regarding the ongoing sporting competition, the current score of the ongoing competition, current probabilities are for the game ball hitting a target, current probabilities are odds for an outcome of the sporting competition, gambling information or the like.

In such implementations, image 64 is superimposed upon game ball 24 in each frame 48 being displayed or in a set of frames. As a result, the image 64 is presented in a continuous fashion on the game ball 24 as the game ball is being propelled, shot or moving during the competition (multiple image frames). As the game ball is floating or otherwise moving through air in the video being presented, image 64 may continuously change to reflect the changing travel parameters of game ball 24 during such flight.

In some implementations, image 64 may change color or otherwise indicate the last team or player to touch the ball 24 in the current frame. In such implementations, as the stream of image frame 48 depict movement of the basketball being repeatedly or concurrently touched by different teams, image 64 may likewise continuously or constantly change to indicate the last player team to touch the ball (based upon changes in spin direction or other image analysis by image processor 46). In some implementations, such as during an instant replay, image 64 may encompass the entirety of game ball 24, wherein the color (or other graphic) of image 64 on the game ball 24 may change color or pattern multiple times from frame to frame indicating at what point in time different teams last touched the game ball.

Image processor 46 virtually or digitally superimposes image 64 in the image frames 48 being displayed. Image processor 46 overlays the pixels of image 64 on top of the underlying pixels of the image captured by camera 44. Image 64 may be opaque or may be at least partially translucent. In some implementations coming in 64 may comprise an outline of an image, wherein the original image of image frame 48 is viewable through the outline.

Image processor 46 superimposes image 64 on game ball 24 in the image being presented on display 32 based upon the location of the tracked region 40 in the image being presented on display 32. In some implementations, image 64 completely fills the boundaries or perimeter of region 40. In some implementations, image 64 is contained within the boundaries of region 40. In some implementations, image 64 is digitally or virtually superimposed at other locations, outside of region 40, at a particular location having a predetermined positioning relative to the centroid or a perimeter of region 40. In such implementations, the location of region 40 serves as a reference point or anchor for locating the superimposed image 64.

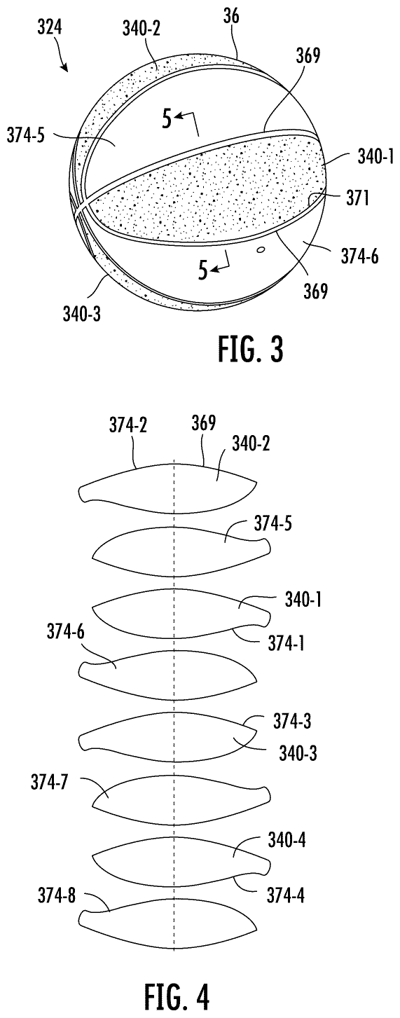

FIG. 3 illustrates an example game ball 324 in the form of an example basketball. In the example illustrated, as shown by FIG. 4, game ball 324 is formed from eight panels 374-1, 374-2, 374-3, 374-4, 374-5, 374-6, 374-7 and 374-8 (collectively referred to as panels 374) . . . As shown FIG. 3, each of such panels, when assembled to form game ball 324, are separated by an intervening strip 371 forming a floor of a respective channel 372. In some implementations, panels 374 are overlaid about a carcass form from an internal inflatable bladder and windings wound about the bladder, strips of rubber or other material positioned between the panels to form floors of the channel 372. In yet other implementations, each of the panels 374 may be part of a single integral unitary body, such as an outer body including all of the panels molded as a single unitary piece along with the channels 372. In some implementations, panels 374 may be formed from a polymer or composite material, such as polyurethane composite. In some implementations, panels 374 may be formed from a natural or a synthetic leather.

As shown by FIG. 3, game ball 324 has an outer surface 36 comprising tracked regions 340-1, 340-2, 340-3, and 340-4 (shown in FIG. 4) (collectively referred to as regions 340). Each of regions 340 is similar to tracked region 40 described above except that each of regions 340 is specifically illustrated as having an outer boundary 369 corresponding to the edges of a corresponding individual panel 374. Tracked regions 340-1, 340-2 and 340-3, 340-4 and their associated panels 374-1, 374-2,374-3, 374-4, respectively, are separated or spaced from one another by intervening panels 374-5, 374-6, 374-7, and 374-8 (untracked, contrast panels). The alternating tracked regions 340 and untracked panels 374 have sufficient contrast to enhance tracking of the rotation of game ball to 24 by camera 44 image processor 46 described above.

In other implementations, game ball 324 may be formed from differently shaped panels or a different number of panels. In other implementations, one or more of regions 340 may have an area having a perimeter wholly contained within their respective individual panel 374 of game ball 324. In some implementations, regions 340 may have a perimeter that corresponds to the perimeter of a set or group of consecutive panels 374. For example, in some implementations, game ball 324 may comprise two tracked regions 340 instead of four, such as where a first tracked region has an area and perimeter corresponding to the area and perimeter of an outline of both of panels 374-1, 374-6, wherein a second tracked region has an area perimeter corresponding to the area and perimeter of an outline of both of panels 374-4 and 374-8 and wherein the remaining panels 374 are not associated with a tracked region.

In some implementations, one or more of regions 340 may extend across multiple panels 374, having an area having a perimeter that does not correspond to a perimeter of a panel 374, but passes through a central portion of a panel 374. In some implementations, regions 340 may be provided along a junction of adjacent panels, such as along channels 372. In some implementations, one or more of regions 340 may be discontinuous in that a particular region 340 surrounds or extends about intermediate portions that are not optically enhanced, portions that may be similar to the other untracked panels 374-5 to 374-8. For example, one or more region 340 may be an annular shape, text, or open/perforate graphics/patterns, rather than a solid continuous unbroken and imperforate layer or area.

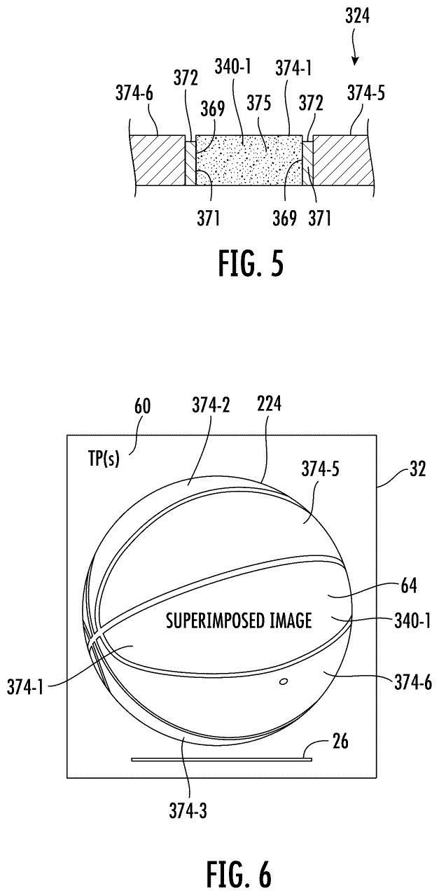

FIG. 5 is a sectional view schematically illustrating a portion of game ball 324 taken along line 5-5 of FIG. 3. For purposes of illustration, FIG. 5 omits additional layers of game ball 324. For example, as discussed above, in some implementations, game ball 324 may additionally comprise a carcass formed by a bladder and windings about the bladder, wherein the illustrated construction overlies the carcass. In some implementations, such windings may be omitted. In some implementations, the construction shown in FIG. 5 is integrally formed as part of a single unitary body, such as a single molded unitary body. In some implementations, one or more additional coatings or films may be applied over an exterior of the illustrated construction to provide a more uniform feel. Such coatings or films may be transparent so as to not interfere with absorption and reflection of light. In some implementations, those panels associated with tracked regions may be differently coated or covered then those panels not associated with tracked regions to assist making panels associated with tracked regions and panels not associated with tracked regions less discernible from one another. For example, panels 374-5 and 375-6 may have an additional outer coating or film having different optical properties than a coating applied over panel 374-1 with his tracked region 340-1. The different coatings may offer a more uniform touch or feel across all of panels 374, while obfuscating any perceivable visible differences between panels 374.

In the example illustrated, panel 374-1 is formed by a blend of materials that optically highlight panel 374-1 and optically distinguish panel 374-1 from panel 374-5 and 374-6 to form tracked region 340-1. In one example, panel 374-1 is formed from a polymer material, such as a polyurethane, wherein the polyurethane (in powder or liquid form) is blended with an additive 375 that enhances absorption of a particular portion of the optical spectrum to form tracked region 340-1. In one example implementation panels 374 is formed from a polymer material having a gravure layer of polyurethane (treated so as to be porous), wherein those panels serving as tracked regions (panel 374-1, 374-2, 374-3 and 374-4) are formed from a blend of the polymer material additionally including the additive.

In the illustrated example, the additive 375 enhances absorption of NIR+ light and only the upper range of wavelengths of the visible spectrum. As a result, in implementation where camera 44 is largely configured to capture the visible spectrum of light, a majority of the visible spectrum of light is not reflected off of tracked region 340-1 and captured by camera 44, but is instead absorbed by tracked region 340-1. In contrast, a much greater portion of the visible spectrum of light impinging panel 374-5 and 374-6 is reflected and captured by camera 44. As discussed above, this may result in tracked region 340-1 (as well as all of the other tracked regions 340) appearing darker in the image frames captured by camera 44. As discussed above, image processor 46 may identify the tracked region 340 as those portions of game ball 324 that are darker in the image frames. By identifying and distinguishing the tracked region 340 from the remaining portions of game ball 324, image processor 46 may output display signals (as described above with respect to block 112 of method 100) based upon the identified location of the tracked regions.

FIG. 6 illustrates display 32 (as part of system 20 with game ball 324 replacing game ball 24) presenting an individual image frame of a stream of image frames (a video) depicting game ball 324 in its associate environment 26 (described above). As shown by FIG. 6, image processor 46 may carry out method 100 described above. In the example illustrated, image processor 46 output display signals causing display 32 to present travel parameters 60 left friend described above) and an example superimposed image 64 on top of the tracked region 340-1.

As discussed above, superimposed image 64 comprises alphanumeric text, graphics, logos or combinations thereof providing information to a viewer. In some implementations, image 64 may comprise a logo, advertising or sponsor information. In some implementations, image 64 may comprise any of the above-mentioned travel parameters example, image 64 may comprise the current rotational speed/spin, spin acceleration, trajectory or positioning or coordinates of game ball 324. Image 64 may present a determined statistic regarding the ongoing sporting competition, the current score of the ongoing competition, current probabilities are for the game ball hitting a target, current probabilities are odds for an outcome of the sporting competition, gambling information or the like.

In such implementations, image 364 is superimposed upon game ball 324 in each frame 48 being displayed or in a set of frames. As a result, the image 64 is presented in a continuous fashion on the game ball 24 as the game ball is being propelled, shot or moving during the competition (multiple image frames). As the game ball is floating or otherwise moving through air in the video being presented, image 64 may continuously change to reflect the changing travel parameters of game ball 24 during such flight.

In some implementations, image 64 may change color or otherwise indicate the last team or player to touch the ball 324 in the current frame. In such implementations, as the stream of image frames 48 depict movement of the basketball being repeatedly or concurrently touched by different teams, image 64 may likewise continuously or constantly change to indicate the last player team to touch the ball (based upon changes in spin direction or other image analysis by image processor 46). In some implementations, such as during an instant replay, image 64 may encompass the entirety of game ball 324, wherein the color (or other graphic) of image 64 on the game ball 324 may change color or pattern multiple times from frame to frame indicating at what point in time different teams last touched the game ball.

Image processor 46 (shown in FIG. 1) virtually or digitally superimposes image 64 in the image frames 48 of the picture or video being displayed. Image processor 46 overlays the pixels of image 64 on top of the underlying pixels of the image captured by camera 44. Image 64 may be opaque or may be at least partially translucent. In some implementations coming in 64 may comprise an outline of an image, wherein the original image of image frame 48 is viewable through the outline.

Image processor 46 superimposes image 64 on game ball 324 in the image being presented on display 32 based upon the location of the one or more tracked regions 340 in the image being presented on display 32. In the illustrated example, image 64 completely fills the boundaries or perimeter of region 340-1. In some implementations, additional images 64 may be virtually superimposed upon other tracked regions 340 of game ball 324. For example, in some implementations, a graphic, logo or the like, serving as advertising or promotions may be superimposed on a first tracked region 340 while particular travel parameters 60 may be in superimposed on a different one of the tracked regions 340 of game ball 324. In the illustrated example, image 64 is contained within the boundaries of region 340-1. In some implementations, image 64 is digitally or virtually superimposed at other locations, outside of region 340-1, at a particular location having a predetermined positioning relative to the centroid or a perimeter of region 340-1. In such implementations, the location of region 340-1 serves as a reference point or anchor for locating the superimposed image 64. As a result, compose images may be placed upon a ball that is static or upon game ball 324 in motion or in flight in a video being presented on display 32.

In one example, each of panels 374 is formed from a polyurethane composition such as commercially available EVO NXT™ polyurethane. In other implementations, other polyurethane compositions or composites may be utilized. In the example, each of panels 374-1, 374-2, 374-3 and 374-4 include an additional additive (not provided in panels 374-5-374-8) in the form of an infrared absorbing dye that has a composition such that a selected range of wavelengths is more readily absorbed by the additive (not reflected). Various commercially available dyes, such as commercially available NIR+ dyes may be suitable. In some implementations, using a dye that omits a carrier or resin (or has a reduced concentration of the carrier or resin) may assist in maintaining a uniform tactile characteristic (grip ability, friction, slickness) across the surface of the game ball. Said another way, any tactile difference between tracked regions and untracked regions is less perceptible to a player. In some implementation, an ink having a carrier or resin may be used. One example dye is the commercially available EPOLIGHT™ 2057 dye in acetone (without a carrier), a green monovalent amminium NIR+ dye commercially available from Epolin, LLC located at Newark, New Jersey. In the example illustrated, the dye is diluted with acetone or a paint thinner to lower the wavelength at which transmission jumps, to within the visible spectrum, (beginning at approximately 680 nm and in some implementations, approximately 780 nm).

In such implementations, the higher the loading rate (ratio of the dye to the polyurethane), the greater the absorption of infrared, near infrared and upper visible spectrum light. However, as such loading increases, the visible appearance of the panel incorporating the composition also darkens, potentially making the contrast between the panel and those adjacent portions of game ball 324 not including the additive more visibly perceivable.

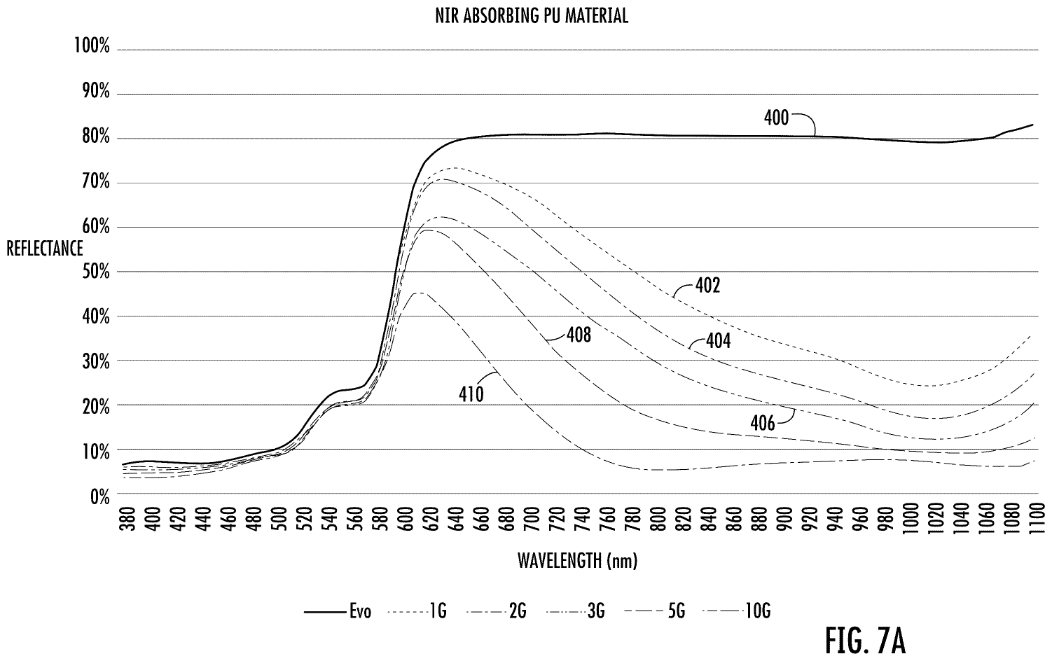

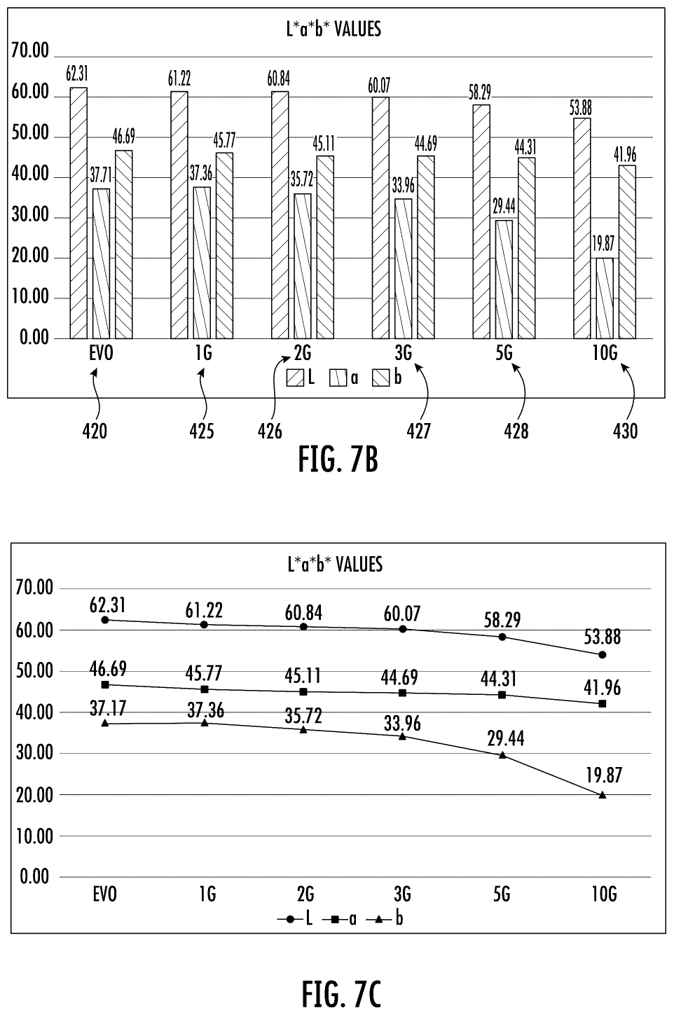

FIG. 7A is a graph depicting relative reflectance properties of the example EVO NXT polyurethane with different loads of the commercially available EPOLIGHT™ 2057 dye in acetone (without a carrier) across the full wavelength spectrum of wavelengths beginning at 380 nm up to 1100 nm. Line 400 indicates the reflectance properties of the EVO NXT polyurethane without any additive, without any loading of infrared dye DT23-34A across the graphed spectrum. Lines 402, 404, 406, 408 and 410 indicate the reflectance is of the EVO NXT polyurethane with loads of 1 g, 2 g, 3 g, 5 g and 10 g per 100 g of the EVO NXT polyurethane, respectively. In the example illustrated, those panels 374 not associated with a tracking region, such as panel 375-5 and 374-6 and 5) may exhibit reflectance similar to line 400 across the spectrum.

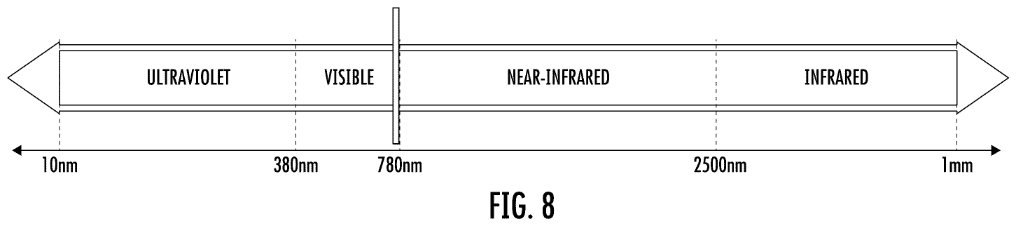

As shown by FIG. 7A, beginning at approximately 580 nm, the amount of light reflected from panel 374-1, from tracked region 340-1, is significantly less than that of panels 374-5 and 374-6 (having a reflectance closely approximated by line 400). The lower amount of reflectance of light having wavelengths in 580 nm and 780 nm (of the visible spectrum (shown in FIG. 8) by tracked region 340-1 (having a reflectance closely approximated by one of lines 402, 404, 406, 408 or 410 depending upon the particular chosen loading) results in tracked region 340-1 appearing much darker than the next adjacent panels 374-5 and 374-6.

As discussed above, the higher degree of loading, such as the loading indicated by line 410, may result in such a contrast between panel 374-1 in the adjacent panels 374-5 and 374-6 so as to be more visibly discernible by players or fans. The slightly lower loading levels as represented by lines 402, 404 and 406 may make tracked region less visibly discernible to the naked eye from the nearby panels not loaded with the dye, yet sufficiently discernible by camera 44 and image processor 46 under extraordinary lighting conditions to facilitate the identification of the location of the tracked region 340-1 by image processor 46

FIGS. 7A and 7B are graphs of one example metric for comparing the visible perceptibility of different tracked regions to the naked eye. The graphs depict sensed L*a*b* values for different implementations of tracked regions 340-1 during impingement by light in the visible spectrum. L*a*b* values describing color using three components: L* for brightness, a* for green-red axis, and b* for blue-yellow axis, providing a perceptible a uniform way to quantify and compare colors. In the example illustrated, the L*a*b* values were measured by illuminating a 22 nm² area of each flat swatch spaced 2.5 to 3 inches from the light source of a spectrophotometer, such as a DATACOLOR 1200-0743 MICROFLASH spectral test of spectrophotometer unit that emits a pulsed (43 to 63 Hz) xenon light for one second with a spectral range of 400 to 700 nm. each of the swatches comprised polyurethane (EVO NXT™) with some of the swatches being loaded with various amounts of NIR+ absorbing dye (EPOLIGHT™ 2057 dye in acetone). The dye was blended with the polyurethane as part of a homogenous mixture, wherein the mixture was then used to form the panel swatches. Panels of the game ball will be formed in a similar manner and have similar properties. Light reflected from the swatches was sensed by the spectrophotometer, wherein the values shown in FIGS. 7A and 7B are averages of multiple swatches for each category.

FIG. 7B is a bar graph for each of the values. The first group of measurements 420 in FIG. 7B are for panels formed from polyurethane (EVO NXT™) without any NIR+ absorbing dye. The remaining group of measurements 425, 426, 427, 428 and 429 in FIG. 7B are for the same polyurethane panels blended with different amounts of an NIR+ absorbing dye (EPOLIGHT™ 2057 dye in acetone). Measurements 425, 425, 425, 428 and 429 are for 1 gram, 2 g, 3 g, 5 g and 10 g of the NIR+ absorbing dye (EPOLIGHT™ 2057 dye in acetone), respectively, per 100 g of the polyurethane material.

FIG. 7C is a line graph illustrating how the L*a*b* values change with respect to the different concentrations of the NIR+ absorbing Dye in the polyurethane base material of the panel. As shown by FIG. 7C, the L*a*b* values remain steady at lower loading rates of the DT23-34A Dye in the EVO NXT™ polyurethane panel material. In particular, each of the L* values for the 1 gram, to 2 gram and 3 g versions of tracked region 340-1 were different from the corresponding values for the EVO polyurethane base material without any Dye by less than 5% ((62.31−60.07)/62.31). Each of the a* values for the 1 gram, 2 gram and 3 g versions of tracked region 340-1 were different from the corresponding values for the EVO polyurethane base material without any dye by less than 5%. Each of the b* values for the 1 gram, 2 gram and 3 g versions of tracked region 340-1 were different from the corresponding values for the EVO polyurethane base material without any dye by less than 10%. An evident color change does take place with the 5 g and 10 g implementations of the tracked region 340-1. Such small percentage differences of the L*a*b* values result in the existence or boundaries of such implementations of the tracked region 340-1 being substantially imperceptible to the naked eye of a player or local fan/observer. As noted above, although substantially imperceptible to the naked eye, such differences may be detected by image processor 46 in the image frames captured by camera 44 to permit image processor 46 to visually identify the locations of the one or more tracked regions 340.

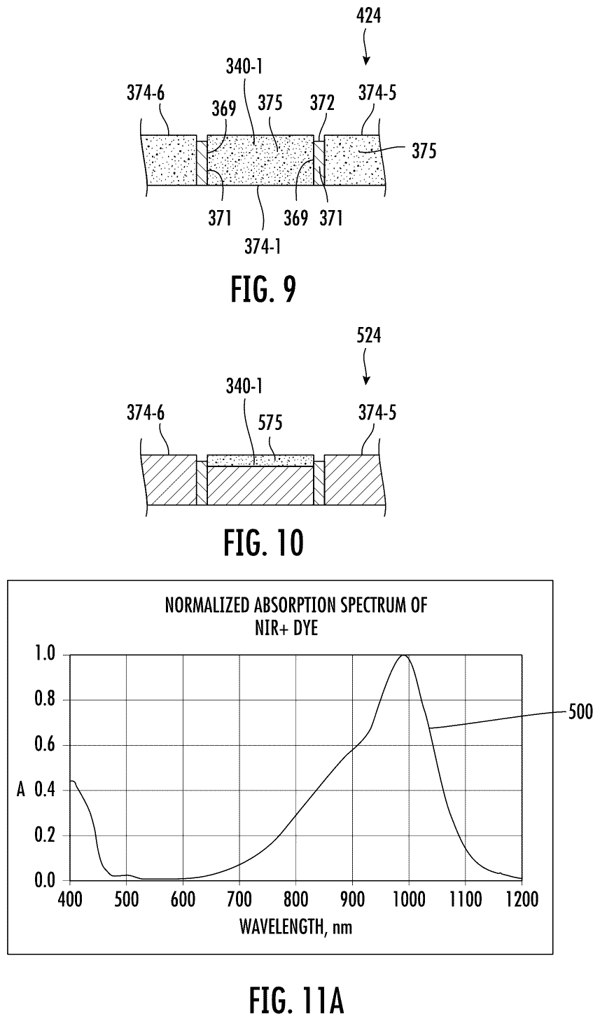

FIG. 9 is a sectional view illustrating portions of an example game ball 424 for use as part of system 20 in place of game ball 24. As with FIG. 5, only selected portions of game ball 424 are illustrated for purposes of illustration. Game ball 424 is similar to game ball 324 in all respects except that the panels 374-5 and 374-6 nearby and on opposite sides of panel 374-1 are also loaded with the same infrared light absorbing dye 375 loading panel 374-1. However, as schematically indicated by lighter stippling, panel 374-1 forming the tracked region 340-1 has a greater degree of loading of the infrared light absorbing additive 375 as compared to the loading of panels 374-5 and 374-6. The relatively larger degree of loading of panel 374-1 is sufficient to create a degree contrast between panel 374-1 and the surrounding panel 374-5, 374-6 that is sufficient by camera 44 an image processor 46, yet much less discernible by the naked eye of a player or in person (not watching images captured by camera 44) observer/fan. Because each of panels 374 is loaded to some extent with the same NIR+ absorbing dye, each of the panels 374 may offer a more similar touch or feel to the player. Said another way, a player handling the game ball 424 may be less likely to notice tactile differences between when he or she is touching a panel 374 also serving as a tracked region 340 and when he or she is touching a panel 374 not serving as a tracked region 340 (a panel loaded with a lower concentration or amount of NIR+ absorbing dye).

FIG. 10 is a sectional view illustrating portions of an example game ball 524 for use as part of system 20 in place of game ball 24. Game ball 524 is similar to game ball 324 in all respects except that the material of panels 374-1, 374-2, 374-3 and 374-4 are not formed from a blended composition of a polymer material and an additive. Instead, each of panels 374-1, 374-2, 374-3 and 374-4 has an upper surface stained or impregnated with an additive or dye 575 that enhances absorption of particular wavelengths of light to optically highlight at least portions of such panels to form tracked regions 340.

As with FIG. 5, only selected portions of game ball 524 are illustrated for purposes of illustration. For example, as discussed above, in some implementations, game ball 524 may additionally comprise a carcass formed by a bladder and windings about the bladder, wherein the illustrated construction overlies the carcass. In some implementations, such windings may be omitted. In some implementations, the construction shown in FIG. 10 (except for the material impregnating the panels to form tracked regions 340) is integrally formed as part of a single unitary body, such as a single molded unitary body. In some implementations, one or more additional coatings or films may be applied over an exterior of the illustrated construction to provide a more uniform feel. Such coatings or films may be transparent so as to not interfere with absorption and reflection of light. In some implementations, those panels associated with tracked regions may be differently coated or covered then those panels not associated with tracked regions to assist making panels associated with tracked regions and panels not associated with tracked regions less discernible from one another. For example, panels 374-5 and 375-6 may have an additional outer coating or film having different optical properties than a coating applied over panel 374-1 with his tracked region 340-1. The different coatings may offer a more uniform touch or feel across all of panels 374, while obfuscating any perceivable visible differences between panels 374.

In the illustrated example, the staining dye 575 is absorbed by and impregnates the material of the underlying panel to enhance absorption of near infrared light and only the upper range of wavelengths of the visible spectrum. As a result, in implementation where camera 44 is largely configured to capture the visible spectrum of light, a majority of the visible spectrum of light is not reflected off of tracked region 340-1 and captured by camera 44, but is instead absorbed by tracked region 340-1. In contrast, a much greater portion of the visible spectrum of light impinging panels 374-5 and 374-6 is reflected and captured by camera 44. As discussed above, this may result in tracked region 340-1 (as well as all of the other tracked regions 340) appearing darker in the image frames captured by camera 44. As discussed above, image processor 46 may identify the tracked region 340 as those portions of game ball 324 that are darker in the image frames. By identifying and distinguishing the tracked region 340 from the remaining portions of game ball 324, image processor 46 may output display signals (as described above with respect to block 112 of method 100) based upon the identified location of the tracked regions.

In one example, each of panels 374 is formed from a leather or synthetic leather. In the example, each of panels 374-1, 374-2, 374-3 and 374-4 are each impregnated or stained with a NIR+ absorbing dye 575 that is not applied to panels 374-5-374-8). In some implementations, the NIR+ absorbing dye or stain is sprayed onto the panel prior to placement on the carcass or onto a substantially completed game ball, where a removable mask may be used to control the extent or boundaries of the tracked region being formed by the dye.

One example of a NIR absorbing dye 575 that is used to stain each of panels 374-1, 374-2, 374-3 and 374-4 is EPOLIGHT™ 2057, a green monovalent amminium NIR+ dye. In some implementations the concentration of the dye may be reduced by adding a reducer, such as acetone, to extend into the visible spectrum. In such implementations, the higher the concentration of the dye the greater the absorption of infrared, near infrared and upper visible spectrum light. However, as such concentration increases, the visible appearance of the panel incorporating the composition also darkens, potentially making the contrast between the panel and those adjacent portions of game ball 524 not including the additive more visibly perceivable.

In some implementations, each of the tracked regions comprise one coat of the Epolight 2057 at a 0.2% concentration. This yields an invisible tracked region that is substantially undetectable with the naked eye, but that which is visible with a camera configured to capture images in the visible spectrum.

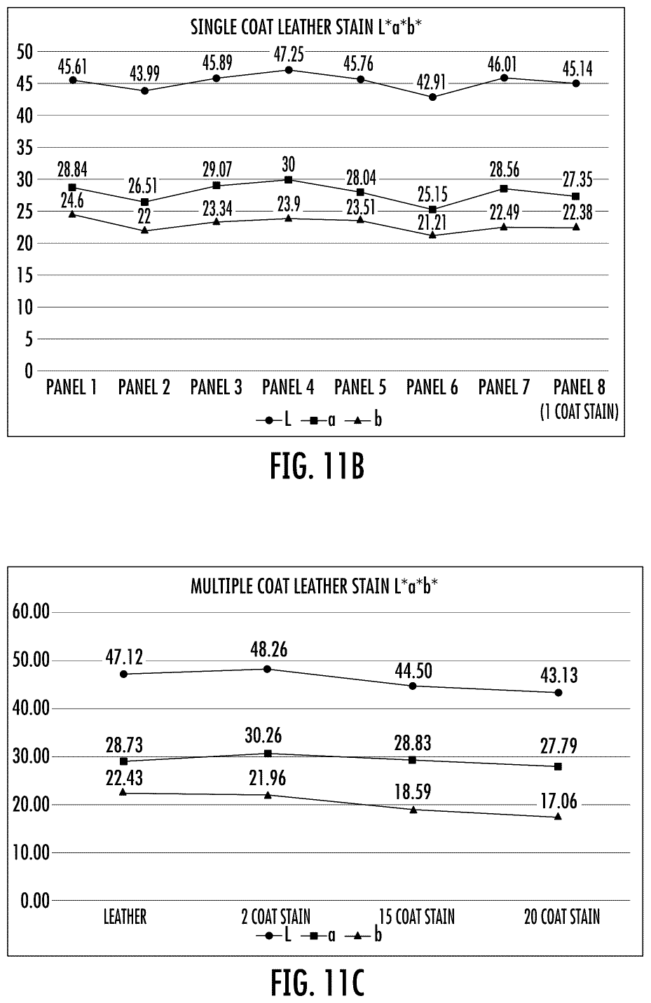

FIG. 11A is a graph depicting the normalize absorption spectrum of NIR+ absorbing stain or dye EPOLIGHT™ 2057 in acetone (at a 0.2% concentration) (without a carrier) across the wavelength spectrum of wavelengths beginning at 400 nm up to 1200 nm. As shown by line 500, the NIR+ absorbing dye absorbs visible light having wavelengths of below approximately 480 nm. The absorption of light from wavelengths above 480 nanometers and up to approximately 680 nm is greatly reduced or near zero. The absorption of light by the dye drastically increases beginning at approximately 680 nm. As shown by line 500, the upper range of visible light is absorbed by the dye (680 nm to 780 nm) and the absorption of near infrared light is maximized for wavelengths near 1000 nm. The stain/dye forming tracked region 340-1 on panel 374-1 may result in such a contrast between panel 374-1 and the adjacent panels 374-5 and 374-6 is substantially undetectable with the naked eye, but that which is visible with a camera to facilitate the identification of the location of the tracked region 340-1 by image processor 46.

FIGS. 11B and 11C are graphs of one example metric for comparing the visible perceptibility of different tracked regions to the naked eye. The graphs depict sensed L*a*b* values for different implementations of tracked regions 340-1 during impingement by light in the visible spectrum. L*a*b* values describing color using three components: L* for brightness, a* for green-red axis, and b* for blue-yellow axis, providing a perceptible a uniform way to quantify and compare colors. In the example illustrated, the L*a*b* values were measured by illuminating a 22 nm² area of each flat swatch spaced 2.5 to 3 inches from the light source of a spectrophotometer, such as a DATACOLOR 1200-0743 MICROFLASH spectral test of spectrophotometer unit that emits a pulsed (43 to 63 Hz) xenon light for one second with a spectral range of 400 to 700 nm. Each of the swatches comprised leather with some of the swatches being additionally stained with various amounts of NIR+ absorbing dye (EPOLIGHT™ 2057 dye in acetone). Light reflected from the swatches was sensed by the spectrophotometer, wherein the values shown in FIGS. 11A and 11B are averages of multiple swatches for each category.

FIG. 11B compares measured or sensed L*a*b* values for a panel (8) upon which one coat of the NIR+ absorbing dye is applied stain is applied to the remaining seven panels (panels 1-7). As shown by FIG. 11B, the L*a*b* values for panel 8 with the stain are largely indiscernible from the same corresponding measurements for those remaining panels without the stain. For the particular leather of the panels (for which was consistent through each of the eight panels), the average L* for panels 1-7 (without the stain) was 45.35 while the measured L* value for the panel including the stain was 45.14, a difference of less than 1%, more specifically less than 0.5% ((45.34−45.14)/45.35). The average a* for panels 1-7 (without the stain) was 23.01 while the measured a* value for the panel including the stain was 22.38, a difference of less than 3%, ((23.01−22.38)/23.01). The average b* for panels 1-7 (without the stain) was 28.02 while the measured a* value for the panel including the stain was 27.35, a difference of less than 3%, ((28.02−27.35)/28.02).

FIG. 11C is a line graph illustrating the L*a*b* values leather without any stain as compared to same leather having different numbers of coats of the NIR+ absorbing dye (EPOLIGHT™ 2057 dye in acetone) staining the leather. Those swatches having two coats of the dye or stain have L*a*b* values that differ from the same leather without dire stain by less than 3% ((48.26−47.12)/47.12), 3% ((22.43−21.96)/22.43) and 6% ((30.26−28.73)/28.73) respectively. The L* and the a* value differences increased with the larger number of coats of the stain.

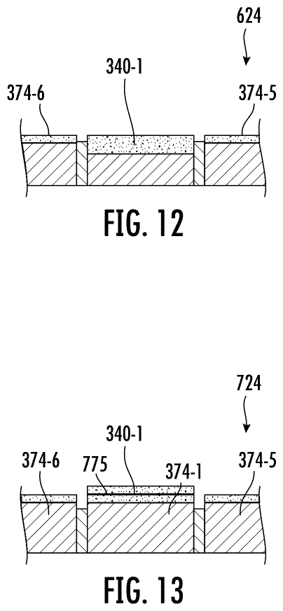

FIG. 12 is a sectional view illustrating portions of an example game ball 624 for use as part of system 20 in place of game ball 24. As with FIG. 5, only selected portions of game ball 624 are illustrated for purposes of illustration. Game ball 624 is similar to game ball 524 in all respects except that the panels 374-5 and 374-6 nearby and on opposite sides of panel 374-1 are also impregnated or stained with the same infrared light absorbing dye 375 applied to panel 374-1. However, as schematically indicated by lighter stippling, panel 374-1 forming the tracked region 340-1 has a greater concentration of the infrared light absorbing additive or dye 375 as compared to the loading of panels 374-5 and 374-6. In one implementation, panel 374-1 is stained with EPOLIGHT™ 2057 having a 0.2% concentration in acetone, whereas panels 374-5 and 374-6 are stained with the EPOLIGHT™ 2057 having a concentration less than 0.2% in acetone. The relatively larger concentration or loading of panel 374-1 is sufficient to create a degree of contrast between panel 374-1 and the surrounding panel 374-5, 374-6 that is sufficient for discernment by camera 44 and image processor 46, yet much less discernible by the naked eye of a player or in person (not watching images captured by camera 44) observer/fan. Because each of panels 374 is loaded to some extent with the same NIR+ absorbing dye, each of the panels 374 may offer a more similar touch or feel to the player. Said another way, a player handling the game ball for 24 may be less likely to notice tactile differences between when he or she is touching a panel 374 also serving as a tracked region 340 and when he or she is touching a panel 374 not serving as a tracked region 340 (a panel loaded with a lower concentration or amount of NIR+ absorbing dye 575).

As further shown by FIG. 12, in some implementations, in addition to the stain 575 having a greater concentration of the NIR+ absorbing material (EPOLIGHT™ 2057 in the example) so as to absorb a greater amount of light in the tracked region 340-1, the amount of the stain (the thickness or penetration depth of the stain) in the tracked region of panel 374-1 may also be greater (a larger number of coatings) as compared to the nearby panels 374-5 and 374-6 to potentially achieve greater light absorption for enhanced contrast. In some implementations, the concentration of the additive or stain 375 may be the same for panels 374-1, 374-5 and 374-6, but wherein the extent of penetration or thickness (number of coatings) is greater in panel 374-1 to form the tracked region 340-1.

FIG. 13 is a sectional view illustrating portions of an example game ball 724 for use as part of system 20 in place of game ball 24. Game ball 724 is similar to game ball 324 in all respects except that the material of panels 374-1, 374-2, 374-3 and 374-4 are not formed from a blended composition of a polymer material and an additive. Instead, each of panels 374-1, 374-2, 374-3 and 374-4 has an upper surface upon which is applied a film or coating 775 that enhances absorption of particular wavelengths of light to optically highlight at least portions of such panels to form tracked regions 340.

As with FIG. 5, only selected portions of game ball 724 are illustrated for purposes of illustration. For example, as discussed above, in some implementations, game ball 724 may additionally comprise a carcass formed by a bladder and windings about the bladder, wherein the illustrated construction overlies the carcass. In some implementations, such windings may be omitted. In some implementations, the construction shown in FIG. 13 (except for the film or coating that forms the tracked regions 340) is integrally formed as part of a single unitary body, such as a single molded unitary body. In some implementations, one or more yet additional coatings or films may be applied over an exterior of the illustrated construction to provide a more uniform feel. Such coatings or films may be transparent so as to not interfere with absorption and reflection of light. In some implementations, those panels associated with tracked regions may be differently coated or covered then those panels not associated with tracked regions to assist making panels associated with tracked regions and panels not associated with tracked regions less discernible from one another. For example, panels 374-5 and 374-6 may have an additional outer coating or film having different optical properties than a coating applied over panel 374-1 with his tracked region 340-1. The different coatings may offer a more uniform touch or feel across all of panels 374, while obfuscating any perceivable visible differences between panels 374.

In the illustrated example, the coating 775 extends above and overlies the underlying panel to enhance absorption of near infrared light and only the upper range of wavelengths of the visible spectrum. As a result, in implementation where camera 44 is largely configured to capture the visible spectrum of light, a majority of the visible spectrum of light is not reflected off of tracked region 340-1 and captured by camera 44, but is instead absorbed by tracked region 340-1. In contrast, a much greater portion of the visible spectrum of light impinging panel 374-5 and 374-6 is reflected and captured by camera 44. As discussed above, this may result in tracked region 340-1 (as well as all of the other tracked regions 340) appearing darker in the image frames captured by camera 44. As discussed above, image processor 46 may identify the tracked region 340 as those portions of game ball 324 that are darker in the image frames. By identifying and distinguishing the tracked region 340 from the remaining portions of game ball 324, image processor 46 may output display signals (as described above with respect to block 112 of method 100) based upon the identified location of the tracked regions.

In one example, each of panels 374 is formed from polymer, such as polyurethan. In the example, each of panels 374-1, 374-2, 374-3 and 374-4 are each at least partially covered with coating 775 having a composition comprising a NIR+ absorbing coating. In some implementations, the NIR+ absorbing coating is sprayed onto the panel prior to placement on the carcass or onto a substantially completed game ball, where a removable mask may be used to control the extent or boundaries of the tracked region being formed by the dye.

One example of a NIR absorbing dye that may be provided by coating 775 is EPOLIGHT™ 2057, a green monovalent amminium NIR+ dye commercially available from Epolin, LLC. In some implementations the concentration of the dye in the composition of coating 775 may be reduced by adding a reducer, such as acetone. In such implementations, the higher the concentration of the dye the greater the absorption of infrared, near infrared and upper visible spectrum light. However, as such concentration increases, the visible appearance of the panel incorporating the composition also darkens, potentially making the contrast between the panel and those adjacent portions of game ball 524 not including the additive more visibly perceivable.

In some implementations, each of the tracked regions comprise one coat of the Epolight 2057 at a 0.2% in acetone concentration. This yields an invisible tracked region that is substantially undetectable with the naked eye, but that which is visible with a camera such as a camera configured to capture image in the visible spectrum

Similar to game ball 624, game ball 724 has panels 374-5 and 374-6 nearby and on opposite sides of panel 374-1 of game ball 724 are also treated with the same infrared light absorbing dye applied to panel 374-1. With game ball 724, panel 374-5 and 374-6 have exterior surfaces that are also covered with a coating 775. However, as schematically indicated by lighter stippling, the coating 775 on panel 374-1 forming the tracked region 340-1 has a greater concentration of the infrared light absorbing additive or dye as compared to the coating 775 on panels 374-5 and 374-6. The relatively larger concentration of the NIR+ absorbing dye in the coating on panel 374-1 is sufficient to create a degree contrast between panel 374-1 and the surrounding panels 374-5, 374-6 that is sufficient to be discerned by camera 44 and image processor 46, yet much less discernible by the naked eye of a player or in person (not watching images captured by camera 44) observer/fan. Because each of panels 374 is covered to some extent with a coating having a composition comprising the same NIR+ absorbing dye, each of the panels 374 may offer a more similar touch or feel to the player. Said another way, a player handling the game ball for 24 may be less likely to notice tactile differences between when he or she is touching a panel 374 also serving as a tracked region 340 and when he or she is touching a panel 374 not serving as a tracked region 340 (a panel loaded with a lower concentration or amount of NIR+ absorbing dye 575). In some implementations, the coating or covering applied to panels 374-5 and 374-6 may omit the NIR+ absorbing dye incorporated into the coating 775 of panel 374-1, wherein the coating or covering applied to panels 374-5 and 374-6 may comprise other dyes or of other compositions so as to lessen any naked eye perceptible or tactile differences between the tracked region 340-1 supported panel 374-1 and nearby panels not supporting or designated as tracked regions, panels 374-5 and 374-6. The coating applied to panels 374-5 and 334-6 may also have a height or thickness corresponding to that of the coating applied to panel 374-1 for uniformity and to reduce perceptible tactile differences.

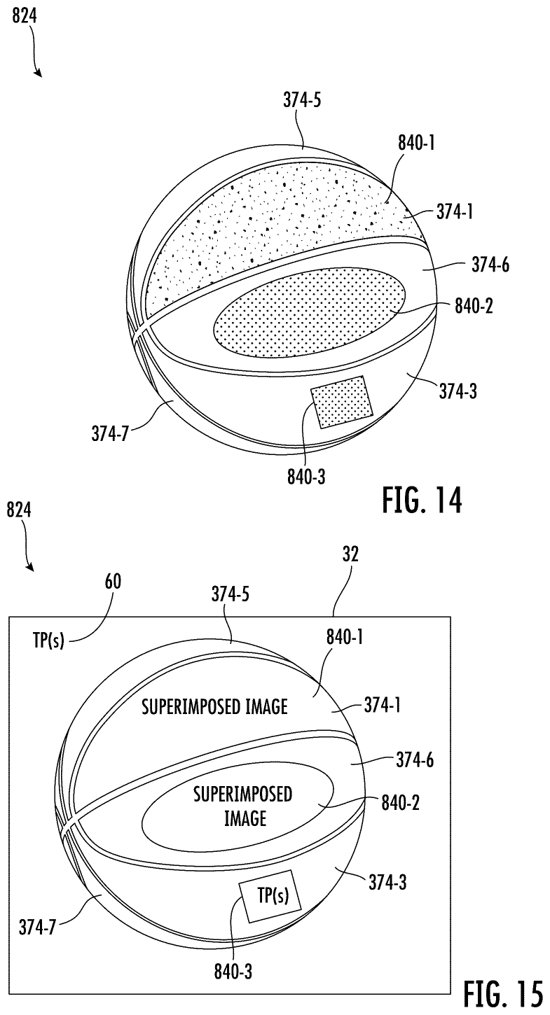

FIG. 14 illustrates an example game ball 824 in the form of a basketball. Basketball 824 is similar to basketball 324 except that basketball 824 comprises tracked regions 840-1, 840-2 and 840-3 (collectively referred to as tracked regions 840). The remaining components of game ball 824 which correspond to components of basketball 324 are numbered similarly.

Tracked region 840-1 is similar to tracked region 340-1 described above. Tracked region 840-1 has an outer perimeter or boundaries corresponding to the outer perimeter boundaries of panel 374-1. Tracked region 840-1 and panel 374-1 may have a construction corresponding to any of tracked regions 340-1 and panels 374-1 of game balls 324, 424, 524, 624 or 724, described above.

Tracked region 840-2 is inset within and has an outer perimeter spaced from the perimeter of panel 374-6. Those portions of panel 374-6 surrounding tracked region 840-2 provide sufficient camera perceptible contrast with respect to tracked region 840-1 of panel 374-1 and the inset or surrounded tracked region 840-2. Tracked region 840-2 may have a construction similar to any of tracked regions 340-1 of game balls 324, 424, 524, 624 or 724. Although tracked region 840-2 is illustrated as an oval, tracked region 840-2 may have other sizes and shapes.

Panels 374-5 and 374-6, which border panel 374-1, may have a construction corresponding to the construction of panels 375-5 and 374-6 of any of game balls 324, 424, 524, 624 or 724 described above, except that panel 374-6 additionally comprises tracked region 840-2. For example, panel 374-6 may comprise a lower loading of additive 375 than panel 374-1 (similar to game ball 424), a lower concentration and/or thickness of the stain 575 than panel 374-1 (similar to game ball 624) or a coating having a lower concentration of NIR+ absorbing dye/dye than panel 374-1 (similar to game ball 724), but where the additional tracked region 840-2 within the perimeter of panel 374-6 has a construction similar to that of the tracked region 340-1 of panel 374-1. In particular, the tracked region 840-2 may comprise a higher degree of loading of additive 375 than the remainder of panel 374-6, a higher concentration and/or thickness of the stain 575 than the remainder of panel 374-6 or a coating having a higher concentration of NIR+ absorbing dye/dye than the remainder of panel 374-6.

Other than its shape and the inclusion of tracked region 840-3 in place of tracked region 840-2, panel 374-3 of game ball 824 is similar to panel 374-6 of game ball 824. Tracked region 840-3 is similar to tracked region 840-2 except that tracked region 840-3 is illustrated as being rectangular and smaller in size. Similar to tracked region 840-2, tracked region 840-3 as a camera perceptible contrast with respect to the remaining surrounding portions of panel 374-3. In some implementations, tracked region 840-3 may comprise a co-molded homogenous layer of the polymer material blended with an NIR+ absorbing dye. In some implementations, tracked region 840-3 may comprise a stain that impregnates the underlying portions of panel 374-3, such as where panel 374-3 form from a leather or synthetic leather. In some implementations, tracked region 840-3 may comprise a film or coating covering the underlying portion of panel 374-3 and form from a composition including an NIR+ absorbing dye.

Although tracked regions 840-2 and 840-3 are illustrated as being provided on panels 374-6 and 374-3, respectively, in other implementations, one or both of tracked regions 840-2 and/or 840-3 may be located on other panels of game ball 824. In some implementations, one or more of tracked regions 840-1, 840-2 and 840-3 may be omitted. Moreover, in some implementations, an individual panel of game ball 824 may include multiple distinct or spaced tracked regions, all inset within the border of the same panel. In some implementations, game ball 824 may comprise multiple panels having the same constructed, sized and/or shaped tracked region.

FIG. 15 illustrates display 32 (as part of system 20 with game ball 324 replacing game ball 24) presenting an individual image frame of a stream of image frames (a video) depicting game ball 824 in its associated environment 26 (described above). As shown by FIG. 15, image processor 46 may carry out method 100 described above. In the example illustrated, image processor 46 outputs display signals causing display 32 to present travel parameters 60 (described above) and example superimposed images 864-1, 864-2 and 864-3 on top of the tracked regions 840-1, 840-2 and 840-3, respectively.

As discussed above, superimposed images 864 comprise alphanumeric text, graphics, logos or combinations thereof providing information to a viewer. In some implementations, images 864 may comprise a logo, advertising or sponsor information. Superimposed images 864 may be different in form. In the example illustrated, image 864-3 comprises any of the above-mentioned travel parameters. For example, image 864-3 may comprise the current rotational speed/spin, spin acceleration, trajectory or positioning or coordinates of game ball 824. Image 864-3 may present a determined statistic regarding the ongoing sporting competition, the current score of the ongoing competition, current probabilities are for the game ball hitting a target, current probabilities are odds for an outcome of the sporting competition, gambling information or the like.

In such implementations, each of images 864 is superimposed upon game ball 824 in each frame 48 being displayed or in a set of frames. As a result, the image 864 is presented in a continuous fashion on the game ball 824 as the game ball is being propelled, shot or moving during the competition (multiple image frames). As the game ball is floating or otherwise moving through air in the video being presented, images 864 may continuously change to reflect the changing travel parameters of game ball 824 during such flight. Alternatively, the virtual superimposing of the individual images 864 may be sequenced during a video or at predetermined times during a video.

In some implementations, processor 46Image processor 46 may be configured to sequence super imposition of the same image amongst different tracked regions at a predetermined frequency or based upon the spin or rotational speed of the game ball (as detected based upon movement of the tracked region). For example, imaging processor 46processor 46 may be configured to automatically present an image on the particular one of a plurality of tracked regions that is currently facing the camera as the game ball is rotating during flight. Said another way, processor 46processor 46 may virtually superimpose an image on a first tracked region when the first tracked region is facing the camera and may automatically virtually superimpose the same image on a second tracked region when the second tracked region is facing the camera during rotation of the game ball.

In some implementations, multiple different images 864 may be virtually superimposed upon a particular tracked region 840 at a predetermined frequency and according to a predetermined sequence or order. In some implementations, imaging processor 46processor 46 may be configured to automatically present a particular superimposed image on a particular one of tracked regions 840 in response to a particular predetermined triggering event, such as during a free-throw, during instant replay, after a made basket, after a made free-throw, during a game timeout, during a tipoff, during a slow motion replay, or after the game ball is ruled out of bounds. The triggering event may be sensed by one or more sensors associated with processor 46 or may be the result of a manual input to processor 46 by an operator.

In some implementations, one or more of images 864 may change color or otherwise indicate the last team or player to touch the ball 824 in the current frame. In such implementations, as the stream of image frames 48 depict movement of the basketball being repeatedly or concurrently touched by different teams, one or more images 864 may likewise continuously or constantly change to indicate the last player team to touch the ball (based upon changes in spin direction or other image analysis by image processor 46). In some implementations, such as during an instant replay, one or more images 864 may encompass the entirety of game ball 324, wherein the color (or other graphic) of image 864 on the game ball 824 may change color or pattern multiple times from frame to frame indicating at what point in time different teams last touched the game ball.

Image processor 46 (shown in FIG. 1) virtually or digitally superimposes images 864 in the image frames 48 of the picture or video being displayed. Image processor 46 overlays the pixels of images 864 on top of the underlying pixels of the image captured by camera 44. Images 864 may be opaque or may be at least partially translucent. In some implementations, images 864 may comprise an outline of an image, wherein the original image of image frame 48 is viewable through the outline.

Image processor 46 superimposes images 864 on game ball 824 in the image being presented on display 32 based upon the location of the one or more tracked regions 840 in the image being presented on display 32. In the illustrated example, image 864-1 completely fills the boundaries or perimeter of region 340-1 while images 864-2 and 864-3 are smaller than the panels upon which they are superimposed in the video.

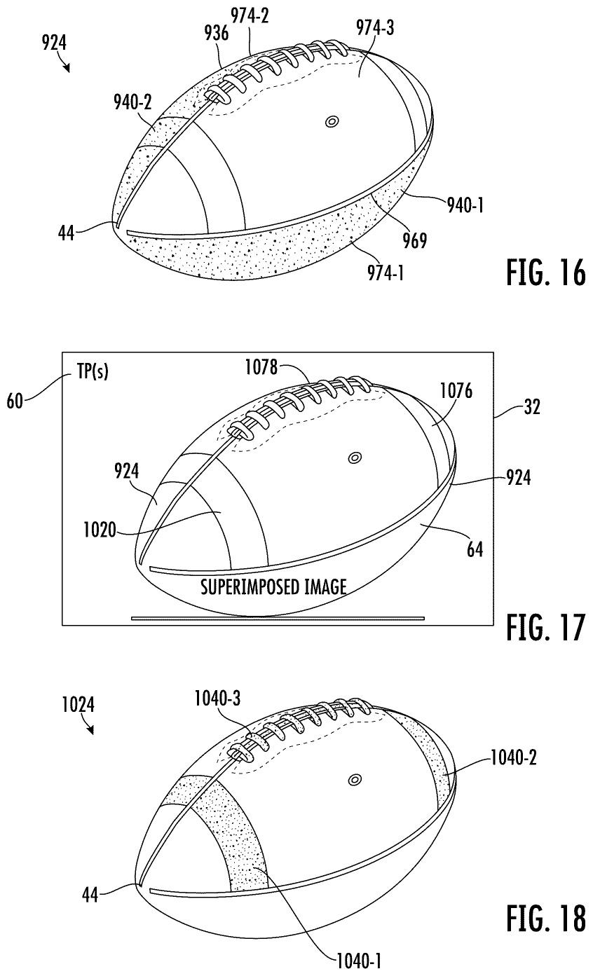

FIG. 16 illustrates an example game ball 924 in the form of an example American style football having a prolate spheroid shape. In the example illustrated, game ball 924 is formed from four panels 974-1, 974-2, 974-3, and a fourth panel (not shown) (collectively referred to as panels 974). In some implementations, panels 974 are overlaid about a carcass formed from an internal inflatable bladder. In yet other implementations, each of the panels 974 may be part of a single integral unitary body, such as an outer body including all of the panels that is molded as a single unitary piece. In some implementations, panels 974 may be formed from a polymer material, such as polyurethane. In some implementations, panels 974 may be formed from a natural or synthetic leather.

As shown by FIG. 16, game ball 924 has an outer surface 936 comprising tracked regions 940-1, and 940-2 (collectively referred to as regions 940). Each of regions 940 is similar to tracked region 40 described above except that each of regions 940 is specifically illustrated as having an outer boundary 969 corresponding to the edges of a corresponding individual panel 974. Tracked regions 940-1 and 940-2 and their associated panels 374-1, 374-2, respectively, are separated or spaced from one another by intervening panels 974-3 and the fourth panel (untracked, contrast panels). The alternating tracked regions 940 and untracked panels 974 have sufficient contrast to enhance tracking of the rotation of game ball 924 by camera 44 and image processor 46 described above.

In other implementations, game ball 924 may be formed from differently shaped panels or a different number of panels. In other implementations, one or more of regions 940 may have an area having a perimeter wholly contained within their respective individual panel 974 of game ball 924. In some implementations, regions 940 may have a perimeter that corresponds to the perimeter of a set or group of consecutive panels 974.

In some implementations, one or more of regions 940 may extend across multiple panels 974, having an area having a perimeter that does not correspond to a perimeter of a panel 974, but passes through a central portion of a panel 974. In some implementations, one or more of regions 940 may be discontinuous in that a particular region 940 surrounds or extends about intermediate portions that are not optically enhanced, portions that may be similar to the other untracked panels. For example, one or more regions 940 may be an annular shape, text, or open/perforate graphics/patterns, rather than a solid continuous unbroken and imperforate layer or area.

In some implementations panels 974-1 and 974-2 and their associated tracked regions 940-1 and 940-2, respectively, may have a construction similar to any of panels 374-1 and tracked regions 340-1 of any of game balls 324, 424, 524, 624 or 724 while the untracked panels 374-3 and 374-4 may have a construction similar to panels 374-5 and 374-6 of any of game balls 324, 424, 524, 624 or 724. In yet other implementations, game ball 924 may comprise one or more tracked regions and the underlying panels similar to tracked regions 840-2 and/or 840-3 and their underlying panels 374-6 or 374-3, as described above, on any of panels 974.

FIG. 17 illustrates display 32 (as part of system 20 with game ball 924 replacing game ball 24) presenting an individual image frame of a stream of image frames (a video) depicting game ball 924 in its associated environment 26 (described above). As shown by FIG. 17, image processor 46 may carry out method 100 described above. In the example illustrated, image processor 46 output display signals causing display 32 to present travel parameters 60 (described above) and an example superimposed image 64 on top of the tracked region 940-1.

As discussed above, superimposed image 64 comprises alphanumeric text, graphics, logos or combinations thereof providing information to a viewer. In some implementations, image 64 may comprise a logo, advertising or sponsor information. In some implementations, image 64 may comprise any of the above-mentioned travel parameters example, image 64 may comprise the current rotational speed/spin, spin acceleration, trajectory or positioning or coordinates of game ball 324. Image 64 may present a determined statistic regarding the ongoing sporting competition, the current score of the ongoing competition, current probabilities are for the game ball hitting a target, current probabilities are odds for an outcome of the sporting competition, gambling information or the like.

In such implementations, image 64 is superimposed upon game ball 924 in each frame 48 being displayed or in a set of frames. As a result, the image 64 is presented in a continuous fashion on the game ball 24 as the game ball is being propelled, shot or moving during the competition (multiple image frames). As the game ball is floating or otherwise moving through air in the video being presented, image 64 may continuously change to reflect the changing travel parameters of game ball 24 during such flight.

Image processor 46 (shown in FIG. 1) virtually or digitally superimposes image 64 in the image frames 48 of the picture or video being displayed. Image processor 46 overlays the pixels of image 64 on top of the underlying pixels of the image captured by camera 44. Image 64 may be opaque or may be at least partially translucent. In some implementations, image may comprise an outline of an image, wherein the original image of image frame 48 is viewable through the outline.

Image processor 46 superimposes image 64 on game ball 324 in the image being presented on display 32 based upon the location of the one or more tracked regions 340 in the image being presented on display 32. In the illustrated example, image 64 completely fills the boundaries or perimeter of region 940-1. In some implementations, additional images 64 may be virtually superimposed upon other tracked regions 340 of game ball 324. For example, in some implementations, a graphic, logo or the like, serving as advertising or promotions may be superimposed on a first tracked region 940 while particular travel parameters 60 may be in superimposed on a different one of the tracked regions 940 of game ball 924. In the illustrated example, image 64 is contained within the boundaries of region 940-1. In some implementations, image 64 is digitally or virtually superimposed at other locations, outside of region 340-1, at a particular location having a predetermined positioning relative to the centroid or a perimeter of region 940-1. In such implementations, the location of region 940-1 serves as a reference point or anchor for locating the superimposed image 64. As a result, compose images may be placed upon a ball that is static or upon game ball 924 in motion or in flight in a video being presented on display 32.

FIG. 18 illustrates an example game ball 1024 in the form of an American Style football having a prolate spheroid shape. Game ball 1024 is similar to game ball 924 except at game ball 1024 comprises tracked regions 1040-1, 1040-2 and 1040-3 in place of tracked regions 940-1 and 940-2. Tracked regions 1040-1 and 1040-2 are contained within stripes 1076 on opposite ends of laces 1078. Tracked regions 1040-1 and 1040-2 are optically highlighted so as to have a camera perceptible contrast with respect to the adjacent and remaining portions of panels 974-2 and 974-3. Tracked regions 940-1 and 940-2 may be formed by a blended composition of a polymer, such as polyurethane, and an NIR+ absorbing additive or dye (similar to tracked region 340-1 of game ball 324). Tracked regions 1040-1 and 1040-2 may be formed by applying an NIR+ absorbing dye that stains or is impregnated into the underlying material of panels 974-2 and 974-3. For example, such path may be formed from a leather synthetic leather, wherein tracked regions 1040-1 and 1040-2 of formed in a fashion similar to that described above with respect to tracked region 340-1 of game balls 524 or 624. Tracked region 1040-1 and 1040-2 may alternatively formed by a coding or film applied to the exterior of panels 974-2 and 974-3. For example, stripes 1076 may be formed by film or coating incorporating an NIR+ absorbing dye. Those portions of panels 974-2 and 974-3 may omit any NIR+ absorbing dye or may include NIR+ absorbing dye at a lower concentration or thickness as described above with respect to panels 374-5 and 374-6 of game balls 424, 624 and 724 described above.

Tracked region 1040-3 is formed upon laces 1078. Laces 1078 may be formed from a composition comprising a blend of materials that includes an NIR+ absorbing dye (similar to panel 374-1 of game ball 324). In other implementations, laces 1078 may be stained or impregnated with an NIR+ absorbing dye (similar to the dye used on panel 374-1 of game balls 524 and 624). In yet other implementations, laces 1078 may have an applied coating or film incorporating an NIR+ absorbing dye (similar to panel 374-1 of game ball 724). The NIR+ absorbing Dye has a concentration such that it creates a camera perceptible contrast with respect to surrounding portions of panels 974-2 and 974-3, yet substantially imperceptible contrast to the naked eye.

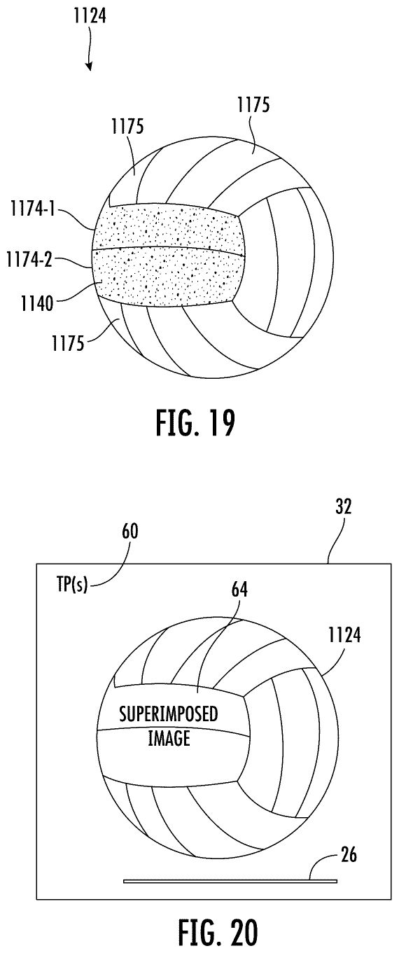

FIG. 19 illustrates an example game ball 1124 in the form of a volleyball. Game ball 1124 comprises panels 1174-1, 1174-2 (collectively referred to as panels 1174) and remaining panels 1175. Panels 1174 1175 may be formed from a leather, a synthetic leather or a polymer, such as polyurethane.

Game ball 1124 further comprises tracked region 1140. Tracked region 1140 extends across panels 1175 111 74-2, having a perimeter corresponding to the perimeter of the set of adjacent panels 1174-1 and 1174-2. Tracked region 1140 may be formed by a blended composition of a polymer, such as polyurethane, and an NIR+ absorbing additive or dye (similar to tracked region 340-1 of game ball 324). Tracked region 1140 may be formed by applying an NIR+ absorbing dye that stains or is impregnated into the underlying material of panels 1174-1 and 1174-2. For example, such path may be formed from a leather synthetic leather, wherein tracked region 1140 is formed in a fashion similar to that described above with respect to tracked region 340-1 of game balls 524 or 624. Tracked region 1140 may alternatively formed by a coating or film applied to the exterior of panels 1174-1 and 1174-2. Those remaining panels 1175 may omit any NIR+ absorbing dye or may include NIR+ absorbing dye at a lower concentration or thickness as compared to panels 1174-1, 1174-2 as described above with respect to panels 374-5 and 374-6 of game balls 424, 624 and 724.

In other implementations, tracked region 1140 may be contained within a single panel or an additional number of panels. In some implementations, game ball them 24 may comprise additional tracked regions at other locations. In some implementations, game 1120 may comprise a tracked region similar in size, shape or construction as tracked regions 840-2 and/or 840-3, wherein the tracked regions are inset within the boundaries of a particular panel.

FIG. 20 illustrates display 32 (as part of system 20 with game ball 924 replacing game ball 24) presenting an individual image frame of a stream of image frames (a video) depicting game ball 1124 in its associated environment 26 (described above). As shown by FIG. 20, image processor 46 may carry out method 100 described above. In the example illustrated, image processor 46 outputs display signals causing display 32 to present travel parameters 60 (described above) and an example superimposed image 64 on top of the tracked region 940-1.

As discussed above, superimposed image 64 comprises alphanumeric text, graphics, logos or combinations thereof providing information to a viewer. In some implementations, image 64 may comprise a logo, advertising or sponsor information. In some implementations, image 64 may comprise any of the above-mentioned travel parameters example, image 64 may comprise the current rotational speed/spin, spin acceleration, trajectory or positioning or coordinates of game ball 1124. Image 64 may present a determined statistic regarding the ongoing sporting competition, the current score of the ongoing competition, current probabilities are for the game ball hitting a target, current probabilities are odds for an outcome of the sporting competition, gambling information or the like.

In such implementations, image 64 is superimposed upon game ball 1124 in each frame 48 being displayed or in a set of frames. As a result, the image 64 is presented in a continuous fashion on the game ball 24 as the game ball is being propelled, shot or moving during the competition (multiple image frames). As the game ball is floating or otherwise moving through air in the video being presented, image 64 may continuously change to reflect the changing travel parameters of game ball 24 during such flight.

Image processor 46 (shown in FIG. 1) virtually or digitally superimposes image 64 in the image frames 48 of the picture or video being displayed. Image processor 46 overlays the pixels of image 64 on top of the underlying pixels of the image captured by camera 44. Image 64 may be opaque or may be at least partially translucent. In some implementations, image may comprise an outline of an image, wherein the original image of image frame 48 is viewable through the outline.

Image processor 46 superimposes image 64 on game ball 1124 in the image being presented on display 32 based upon the location of the tracked region 1140 in the image being presented on display 32. In the illustrated example, image 64 completely fills the boundaries or perimeter of region 1140. In the illustrated example, image 64 is contained within the boundaries of region 940-1. In some implementations, image 64 is digitally or virtually superimposed at other locations, outside of region 1140, at a particular location having a predetermined positioning relative to the centroid or a perimeter of region 1140. In such implementations, the location of region 1140 serves as a reference point or anchor for locating the superimposed image 64. As a result, compose images may be placed upon a ball that is static or upon game ball 1124 in motion or in flight in a video being presented on display 32.

In some implementations, imaging processor 46 may virtually superimpose multiple different images 64 in a sequence manner during a video or at predetermined times during a video. In some implementations, multiple different images 864 may be virtually superimposed upon a particular tracked region at a predetermined frequency and according to a predetermined sequence or order. In some implementations, imaging processor 46 may be configured to automatically present a particular superimposed image on tracked region 1140 of game ball 1124 in response to a particular predetermined triggering event, such as during a free-throw, during instant replay, after a made basket, after a made free-throw, during a game timeout, during a tipoff, during a slow motion replay, or after the game ball is ruled out of bounds. The triggering event may be sensed by one or more sensors associated with processor 46 or may be the result of a manual input to processor 46 by an operator.

In some implementations, game ball 1124 may comprise additional tracked regions 1140 associated with other panels 1175. In some implementations, the additional tracked regions may be similar to tracked region 1140, but on other panels 1175. In still other implementations, the additional tracked regions may be inset within a particular panel, similar to tracked regions 840-2 and 840-3 described above with respect to game ball 824.

In such implementations, a graphic, logo or the like, serving as advertising or promotions may be superimposed on a first tracked region while the same or a different image, such as a particular travel parameter 60, may be in superimposed on a different one of the tracked regions of game ball 1124. In implementations where game ball 1124 comprises multiple tracked regions, processor 46 may be configured to sequence the superimposition of the same image amongst different tracked regions at a predetermined frequency or based upon the spin or rotational speed of the game ball (as detected based upon movement of the tracked region). For example, imaging processor 46 may be configured to automatically present an image on the particular one of a plurality of tracked regions that is currently facing the camera as the game ball is rotating during flight. Said another way, processor 46 may virtually superimpose an image on a first tracked region when the first tracked region is facing the camera and may automatically virtually superimpose the same image on a second tracked region when the second tracked region is facing the camera during rotation of the game ball. In some implementations, different triggering events (described above) may cause imaging processor 46 to superimpose different images on different particular tracked regions of game ball 1124.

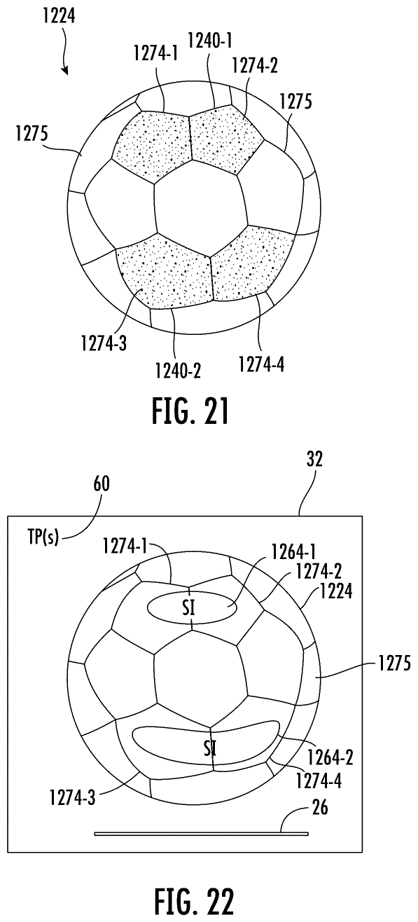

FIG. 21 illustrates an example game ball 1224 in the form of a soccer ball. Game ball 1224 comprises panels 1274-1, 1274-2, 1274-3, 1274-4 (collectively referred to as panels 1274) and remaining panels 1275. Panels 1274 and 1275 may be formed from a leather, a synthetic leather or a polymer, such as polyurethane or polyvinylchloride (PVC).

Game ball 1224 further comprises tracked region 1240-1 and 1240-2. Tracked regions 1240 each extend across panels. Tracked region 1240-1 extends across and has a boundary defined by the boundaries of panels 1274-1 and 1274-2. Tracked region 1240-2 extends across and has a boundary defined by the boundaries of panels 1274-3 and 1274-4. In some implementations, the tracked regions may be inset within a particular panel, similar to tracked regions 840-2 and 840-3 described above with respect to game ball 824.

Tracked regions 1240 may be formed by a blended composition of a polymer, such as polyurethane, and an NIR+ absorbing additive or dye (similar to tracked region 340-1 of game ball 324). Tracked regions 1240 may be formed by applying an NIR+ absorbing dye that stains or is impregnated into the material of panels 1274-1 1274-2, 1274-3, 1274-4. For example, such panels may be formed from a leather synthetic leather, wherein tracked regions 1240 are formed in a fashion similar to that described above with respect to tracked region 340-1 of game balls 524 or 624. Tracked regions 1240 may alternatively formed by a coating or film applied to the exterior of the underlying panels. Those remaining panels 1275 may omit any NIR+ absorbing dye or may include NIR+ absorbing dye at a lower concentration or thickness as compared to panels 1274-1, 1274-2, 1274-3 and 1274-4 as described above with respect to panels 374-5 and 374-6 of game balls 424, 624 and 724.

FIG. 22 illustrates display 32 (as part of system 20 with game ball 924 replacing game ball 24) presenting an individual image frame of a stream of image frames (a video) depicting game ball 1224 in its associated environment 26 (described above). As shown by FIG. 22, image processor 46 may carry out method 100 described above. In the example illustrated, image processor 46 output display signals causing display 32 to present travel parameters 60 (described above) and example superimposed images 1264-1, and 1264-2 on top of the tracked region 1240-1 and 1240-2, respectively.

As discussed above, superimposed image 1264 comprises alphanumeric text, graphics, logos or combinations thereof providing information to a viewer. In some implementations, image 1264 may comprise a logo, advertising or sponsor information. In some implementations, image 64 may comprise any of the above-mentioned travel parameters example, image 64 may comprise the current rotational speed/spin, spin acceleration, trajectory or positioning or coordinates of game ball 1224. Image 64 may present a determined statistic regarding the ongoing sporting competition, the current score of the ongoing competition, current probabilities are for the game ball hitting a target, current probabilities are odds for an outcome of the sporting competition, gambling information or the like.

In such implementations, images 1264 are superimposed upon game ball 1224 in each frame 48 being displayed or in a set of frames. As a result, the image 64 is presented in a continuous fashion on the game ball 1224 as the game ball is being propelled, shot or moving during the competition (multiple image frames). As the game ball is floating or otherwise moving through air in the video being presented, image 64 may continuously change to reflect the changing travel parameters of game ball 24 during such flight.

Image processor 46 (shown in FIG. 1) virtually or digitally superimposes images 1264 in the image frames 48 of the picture or video being displayed. Image processor 46 overlays the pixels of images 1264 on top of the underlying pixels of the image captured by camera 44. Images 1264 may be opaque or may be at least partially translucent. In some implementations, image may comprise an outline of an image, wherein the original image of image frame 48 is viewable through the outline.

Image processor 46 superimposes images 1264 on game ball 1224 in the image being presented on display 32 based upon the location of the tracked regions 1240 in the image being presented on display 32. In some implementations, images 1264 may be digitally or virtually superimposed at other locations, outside of one or both of regions 1240, at a particular location having a predetermined positioning relative to the centroid or a perimeter of region 1140. In such implementations, the location of regions 1240 serve as a reference point or anchor for locating the superimposed images 1264. As a result, compose images may be placed upon a ball that is static or upon game ball 1224 in motion or in flight in a video being presented on display 32.

In some implementations, imaging processor 46 may virtually superimpose multiple different images 1264 in a sequenced manner during a video or at predetermined times during a video. In some implementations, multiple different images 1264 may be virtually superimposed upon a particular tracked region at a predetermined frequency and according to a predetermined sequence or order. In some implementations, imaging processor 46 may be configured to automatically present a particular superimposed image on a particular one of tracked regions 1240 of game ball 1224 in response to a particular predetermined triggering event, such as after a made goal, after a save, during instant replay, during a game timeout, during a slow motion replay, or after the game ball is ruled out of bounds. The triggering event may be sensed by one or more sensors associated with processor 46 or may be the result of a manual input to processor 46 by an operator.

In such implementations, a graphic, logo or the like, serving as advertising or promotions may be superimposed on a first tracked region while the same or a different image, such as a particular travel parameter 60, may be in superimposed on a different one of the tracked regions of game ball 1124. In some implementations, processor 46 may be configured to sequence the superimposition of the same image amongst different tracked regions at a predetermined frequency or based upon the spin or rotational speed of the game ball (as detected based upon movement of the tracked region). For example, imaging processor 46 may be configured to automatically present an image on the particular one of a plurality of tracked regions that is currently facing the camera as the game ball is rotating during flight. Said another way, processor 46 may virtually superimpose an image on a first tracked region when the first tracked region is facing the camera and may automatically virtually superimpose the same image on a second tracked region when the second tracked region is facing the camera during rotation of the game ball. In some implementations, different triggering events (described above) may cause imaging processor 46 to superimpose different images on different particular tracked regions of game ball 1224.

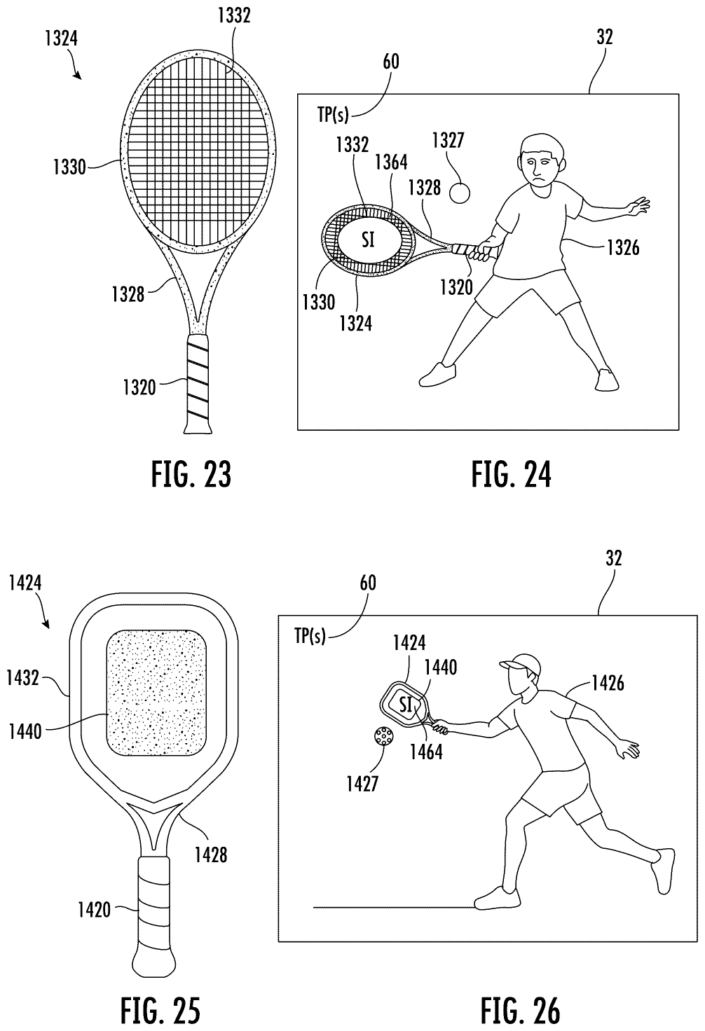

The above implementations provide examples of how a game ball may be optically highlighted for tracking by a camera without substantially altering the appearance, touch or performance of the game ball to a player or fans. In addition to game balls, other sporting equipment may also be optically highlighted to facilitate tracking of movement of the sporting equipment and/or to virtually superimpose images upon surfaces or about surfaces of the sporting equipment. FIG. 23 illustrates an example piece of sporting equipment, in the form of a tennis racket 1324, that has been optically highlighted for such tracking.

Tennis racket 1324 comprises a handle portion 1320, a throat portion 1328, a hoop 1330 and stringing 1332. In the example illustrated, throat portion 1328, hoop 1330 and stringing 1332 each comprise an NIR+ absorbing material that is substantially imperceptible to the naked eye, but that offer sufficient contrast with the surrounding environment for being perceived by any camera with extraordinary lighting. In some implementations, the throat portion 1328 and the hoop 1330 comprise a composition of a blend of materials including an NIR+ absorbing dye (similar to the dye of panel 374-1 of game ball 324). In some implementations, the throat portion 1328 and the hoop 1330 are impregnated with an NIR+ absorbing dye (similar to the dye of panel 374-1 of game balls 524 or 624). In yet other implementations, the throat portion 1328 and the hoop 1330 are covered or coated with a coating or film including an NIR+ absorbing dye. For example, the NIR+ dye (with acetone) described above with respect to the game balls may be sprayed onto the throat portion 1328 and hoop 1330. The NIR+ dye forms a tracked region. In some implementations, NIR+ dye may be sprayed or otherwise applied to selected portions of the throat portion 1328 or the hoop 1330.

In the example illustrated, stringing 1332 additionally comprises an NIR+ absorbing dye. In some implementations, a composition comprising an NIR+ absorbing dye, similar to that described above with respect to game ball 524) is sprayed onto stringing 1332. In some implementations, the NIR+ absorbing dye on stringing 1332 may be omitted. In still other implementations, the NIR+ absorbing treatment of throat portion 1328 and/or hoop 1330 may be omitted.

FIG. 24 illustrates display 32 (as part of system 20 with tennis racket 1324 replacing game ball 24) presenting an individual image frame of a stream of image frames (a video) depicting tennis racket 1324 in its associated environment during play by a player 1326 with respect to tennis ball 1327. As shown by FIG. 24, image processor 46 may carry out a method similar to method 100 described above except that the tracked region is identified with respect to tennis racket 1324. In the example illustrated, image processor 46 output display signals causing display 32 to present travel parameters 60 (described above) which are based on the tracked movement of tennis racket 1324 rather than the tracked movement of the game ball and example superimposed image 1364 on top of the tracked region or at least one of throat portion 1328, hoop 1330 and stringing 1332. In implementations where stringing 1332 does not serve as a tracked region and is not treated with an NIR+ absorbing material, imaging processor 46 may determine the outline of stringing 1332 based upon the NIR+ absorbing treatment applied to hoop 1330, wherein imaging processor 46 superimposes image 1364 over stringing 1332 based upon the outline provided by the camera captured image and the determined perimeter of hoop 1330 enhanced by the NIR+ absorbing material of hoop 1330.

In the example illustrated, image 1364 comprises a graphic virtually superimposed on racket 1324. As discussed above with the other superimposed images, superimposed image 1364 may comprise alphanumeric text, graphics, logos or combinations thereof providing information to a viewer. In some implementations, image 1364 may comprise a logo, advertising or sponsor information. In some implementations, image 1364 may comprise any of the above-mentioned travel parameters example, image 1364 may comprise the current acceleration, speed, trajectory or positioning or coordinates of racket 1324. Image 1364 may present a determined statistic regarding the ongoing sporting competition, the current score of the ongoing competition, current probabilities are for the game ball hitting a target, current probabilities are odds for an outcome of the sporting competition, gambling information or the like.

In such implementations, image 1364 is superimposed upon racket 1324 in each frame 48 being displayed or in a set of frames. As a result, the image 1364 is presented in a continuous fashion on racket 1324 as the racket 1324 is being moved during the competition (multiple image frames). The racket is swung or otherwise moving through air in the video being presented, image 1364 may continuously change to reflect the changing travel parameters of racket 1324 during a swing.

Image processor 46 (shown in FIG. 1) virtually or digitally superimposes images 1364 in the image frames 48 of the picture or video being displayed. Image processor 46 overlays the pixels of images 1364 on top of the underlying pixels of the image captured by camera 44. Images 1364 may be opaque or may be at least partially translucent. In some implementations, image may comprise an outline of an image, wherein the original image of image frame 48 is viewable through the outline.

In some implementations, imaging processor 46 may virtually superimpose multiple different images 1364 in a sequenced manner during a video or at predetermined times during a video. In some implementations, multiple different images 1364 may be virtually superimposed upon a particular tracked region at a predetermined frequency and according to a predetermined sequence or order. In some implementations, imaging processor 46 may be configured to automatically present a particular superimposed image on racket 1324 in response to a particular predetermined triggering event, such as during instant replay, during a serve, during a game timeout, between points, between games or sets, during a slow-motion replay, or after the tennis ball is ruled out of bounds. The triggering event may be sensed by one or more sensors associated with processor 46 or may be the result of a manual input to processor 46 by an operator.

FIG. 25 illustrates an example piece of sporting equipment, in the form of a pickle ball paddle or racket 1424, that has been optically highlighted for tracking by a camera. Pickle ball racket 1424 comprises a handle portion 1420, a throat portion 1428, and a head portion 1432. In the example illustrated, head portion 1432 comprises a tracked region 1440 comprising an NIR+ absorbing material such that the tracked region 1440 is substantially imperceptible to the naked eye while offering sufficient contrast with the surrounding environment for being perceived by any camera with extraordinary lighting. In some implementations, tracked region 1440 comprises a composition of a blend of materials including an NIR+ absorbing dye (similar to that of panel 374-1 of game ball 324). In some implementations, tracked region 1440 is impregnated with an NIR+ absorbing dye (similar to that of panel 374-1 of game balls 524 or 624). In yet other implementations, covered or coated with a coating or film including an NIR+ absorbing dye. For example, the NIR+ dye (with acetone) described above with respect to the game balls may be sprayed onto the throat portion 1328 and hoop 1330. The NIR+ dye forms a tracked region. In some implementations, NIR+ dye may be sprayed or otherwise applied to selected portions of the throat portion 1328 or the hoop 1330.

FIG. 26 illustrates display 32 (as part of system 20 with pickle ball racket 1424 replacing game ball 24) presenting an individual image frame of a stream of image frames (a video) depicting pickle ball racket 1424 in its associated environment during play by a player 1426 with respect to pickle ball 1427. As shown by FIG. 26, image processor 46 may carry out a method similar to method 100 described above except that the tracked region is identified with respect to pickle ball racket 1424. In the example illustrated, image processor 46 output display signals causing display 32 to present travel parameters 60 (described above) which are based on the tracked movement of pickle ball racket 1424 rather than the tracked movement of the game ball and example schematically illustrated superimposed image 1464 on top of the tracked region 1440. In implementations central portions of head portion 1432 are not treated with an NIR+ absorbing material, imaging processor 46 may determine the outline of head portion 1432 based upon the NIR+ absorbing treatment applied to just the perimeter of head portion 1432, wherein imaging processor 46 superimposes image 1464 over central portions of head portion 1432 based upon the outline provided by the camera captured image and the determined perimeter of head portion 1432 enhanced by the NIR+ absorbing material of the perimeter of head portion 1432.

As discussed above with the other superimposed images, superimposed image 1464 may comprise alphanumeric text, graphics, logos or combinations thereof providing information to a viewer. In some implementations, image 1464 may comprise a logo, advertising or sponsor information. In some implementations, image 1464 may comprise any of the above-mentioned travel parameters example, image 1464 may comprise the current acceleration, speed, trajectory or positioning or coordinates of racket 1424. Image 1464 may present a determined statistic regarding the ongoing sporting competition, the current score of the ongoing competition, current probabilities are for the game ball hitting a target, current probabilities are odds for an outcome of the sporting competition, gambling information or the like.

In such implementations, image 1464 is superimposed upon racket 1424 in each frame 48 being displayed or in a set of frames. As a result, the image 1464 is presented in a continuous fashion on racket 1424 as the racket 1424 is being moved during the competition (multiple image frames). The racket is swung or otherwise moving through air in the video being presented, image 1464 may continuously change to reflect the changing travel parameters of racket 1424 during a swing.

Image processor 46 (shown in FIG. 1) virtually or digitally superimposes images 1464 in the image frames 48 of the picture or video being displayed. Image processor 46 overlays the pixels of images 1464 on top of the underlying pixels of the image captured by camera 44. Images 1464 may be opaque or may be at least partially translucent. In some implementations, image may comprise an outline of an image, wherein the original image of image frame 48 is viewable through the outline.

In some implementations, imaging processor 46 may virtually superimpose multiple different images 1464 in a sequenced manner during a video or at predetermined times during a video. In some implementations, multiple different images 1464 may be virtually superimposed upon tracked region 1440 at a predetermined frequency and according to a predetermined sequence or order. In some implementations, imaging processor 46 may be configured to automatically present a particular superimposed image on racket 1424 in response to a particular predetermined triggering event, such as during instant replay, after point, between serves, during a game timeout, during a slow-motion replay, or after the game ball is ruled out of bounds. The triggering event may be sensed by one or more sensors associated with processor 46 or may be the result of a manual input to processor 46 by an operator.

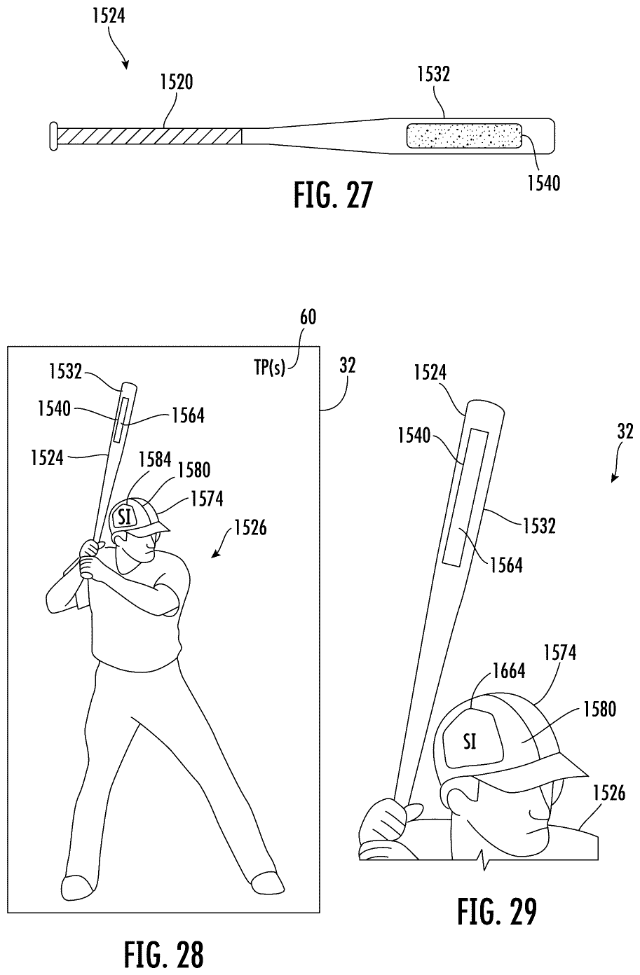

FIG. 27 illustrates an example piece of sporting equipment, in the form of a ball bat 1524, that has been optically highlighted for tracking by a camera. Ball bat 1520 comprises a handle portion 1520 and a barrel 1532. In the example illustrated, barrel 1532 comprises a tracked region 1540 comprising an NIR+ absorbing material such that the tracked region 1540 is substantially imperceptible to the naked eye while offering sufficient contrast with the surrounding environment for being perceived by any camera with extraordinary lighting. In some implementations, tracked region 1540 comprises a composition of a blend of materials including an NIR+ absorbing dye (similar to that of panel 374-1 of game ball 324). In some implementations, tracked region 1540 is impregnated with an NIR+ absorbing dye (similar to that of panel 374-1 of game balls 524 or 624). In yet other implementations, portions of barrel 1532 are covered or coated with a coating or film including an NIR+ absorbing dye to form tracked region 1540. For example, the NIR+ dye (with acetone) described above with respect to the game balls may be sprayed onto a selected portion of barrel 1532. The NIR+ dye forms a tracked region.

FIGS. 28 and 29 illustrates display 32 (as part of system 20 with bat 1524 replacing game ball 24) presenting an individual image frame of a stream of image frames (a video) depicting bat 1524 in its associated environment during play by a player 1526. As shown by FIG. 28, image processor 46 may carry out a method similar to method 100 described above except that the tracked region is identified with respect to bat 1524. In the example illustrated, image processor 46 output display signals causing display 32 to present travel parameters 60 (described above) which are based on the tracked movement of bat 1524 rather than the tracked movement of the game ball and example schematically illustrated superimposed image 1564 on top of the tracked region 1540.

As discussed above with the other superimposed images, superimposed image 1564 may comprise alphanumeric text, graphics, logos or combinations thereof providing information to a viewer. In some implementations, image 1564 may comprise a logo, advertising or sponsor information. In some implementations, image 1564 may comprise any of the above-mentioned travel parameters example, image 1564 may comprise the current acceleration, speed, trajectory or positioning or coordinates of bat 1524. Image 1564 may present a determined statistic regarding the ongoing sporting competition, the current score of the ongoing competition, current probabilities are for the game ball hitting a target, current probabilities are odds for an outcome of the sporting competition, gambling information or the like.

In such implementations, image 1564 is superimposed upon ball bat 1524 in each frame 48 being displayed or in a set of frames. As a result, the image 1464 is presented in a continuous fashion on racket 1424 as the bat 1524 is being moved during the competition (multiple image frames). While the bat 1524 is swung or otherwise moving through air in the video being presented, image 1564 may continuously change to reflect the changing travel parameters of bat 1524 during a swing.

Image processor 46 (shown in FIG. 1) virtually or digitally superimposes images 1564 in the image frames 48 of the picture or video being displayed. Image processor 46 overlays the pixels of images 1564 on top of the underlying pixels of the image captured by camera 44. Images 1564 may be opaque or may be at least partially translucent. In some implementations, image may comprise an outline of an image, wherein the original image of image frame 48 is viewable through the outline.

In some implementations, imaging processor 46 may virtually superimpose multiple different images 1564 in a sequenced manner during a video or at predetermined times during a video. In some implementations, multiple different images 1564 may be virtually superimposed upon tracked region 1540 at a predetermined frequency and according to a predetermined sequence or order. In some implementations, imaging processor 46 may be configured to automatically present a particular superimposed image on that 1524 in response to a particular predetermined triggering event, such as during instant replay, while the batter is awaiting a pitch, in response to the bat being held sufficiently still (motion less than a predetermined amount of movement or acceleration), after the swing of the bat, during a slow motion replay, or after a homerun. The triggering event may be sensed by one or more sensors associated with processor 46 or may be the result of a manual input to processor 46 by an operator.

As further shown by FIGS. 28 and 29, the batter's helmet 1574 may additionally be provided with a tracked region 1580 formed by the controlled application of an NIR+ absorbing Dye (similar to the dye apply to bat 1524. As described above, the NIR+ absorbing dyes applied at a concentration such that tracked region 1580 is substantially imperceptible to the naked eye or at least local fans or observers, but offer sufficient contrast for being perceived by a camera with extraordinary lighting to distinguish or identify the boundaries of the tracked region 1580 from remaining portions of the batting helmet 1574. This location may be utilized by imaging processor 46 to control the positioning of a superimposed image 1584 onto the batting helmet 1574.

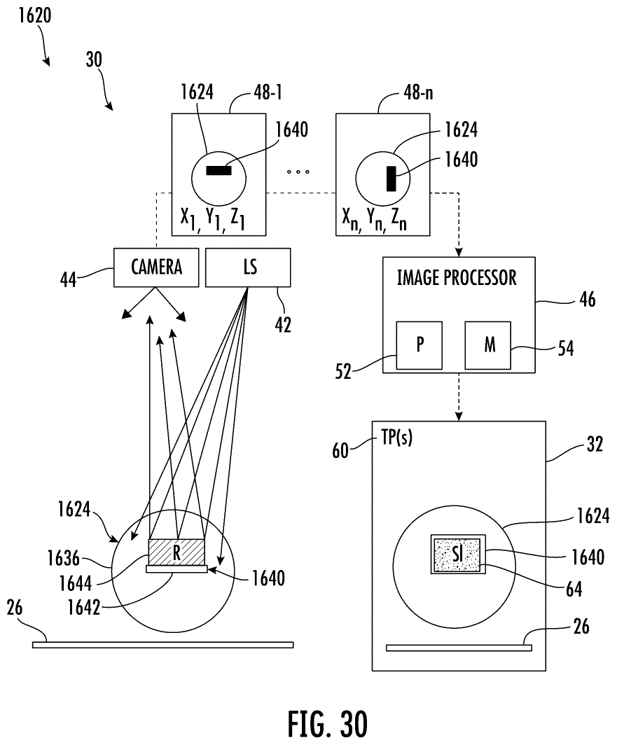

FIG. 30 is a diagram schematically illustrating portions of an example tracking system 1620. Tracking system 1620 is similar to tracking system 20 described above except that tracking system 1620 comprises game ball 1624 in place of game ball 24. The remaining components of tracking system 1620 which correspond to components of tracking system 20 are numbered similarly.

As with tracking system 20, tracking system 1620 is configured to optically track a moving sport object, such as a game ball, a paddle or racket, a ball bat or other sporting equipment based upon light (in the visible spectrum and/or outside the visible spectrum) absorbed and/or reflected from the sport object. The sport object is optically altered or enhanced to facilitate better tracking. For example, the sport object may be altered so as to include a particular tracked region or multiple tracked regions that have a level or degree of optical contrast with other regions or portions of the sport object such that the tracked regions are more easily distinguished by an image processing system for tracking movement of the tracked region. This contrast may be achieved by optically highlighting the tracked region for perception by a camera and image processing system. Such optical highlighting may be achieved by providing tracked regions with a higher degree of reflectivity for particular wavelengths of light while inhibiting the reflection of a majority of visible wavelengths of light. The higher degree of reflection of the particular wavelength of light by the tracked region permits the location, shape and/or size of the tracked region to be discerned by an image processing system without the optical “highlighting” of the tracked region being perceptibly obvious to an untrained naked eye of a sport player or an observer/fan given the typical lighting conditions for the sporting competition or event.

In some implementations, tracking system 20 tracks the sport object so as to analyze and present or display information pertaining to movement characteristics or travel parameters of the sport object, such as spin direction, spin acceleration, spin speed, trajectory and the like. In some implementations, tracking system 1620 may further draw and display or present conclusions based upon the travel parameters of sport object. For example, tracking system 1620 may determine the last team or player to touch a game ball before the game ball goes out of bounds.

In some implementations, tracking system 1620 may additionally or alternatively track movement of the sport object to identify a predefined surface or region of the sporting object upon which a virtual image may be superimposed on the particular region of the sport object as part of a video presentation, such as substantial real-time during a live broadcast, during an instant replay are as part of a video recording of a sporting event or video clips or highlights of the sporting event. In some implementations, the virtual image may be superimposed while the sport object is in motion. In some implementations, the virtual image may comprise advertising or sponsor information, current movement or travel characteristics of the game ball (its current velocity, spin of the like), or other information pertaining to the competition (the current score, statistics, probabilities of a score or of a win, game time or remaining game time, remaining shot clock time,, team last touch, or the like.

Tracking system 20 comprises a sporting object or sporting equipment, shown as an example game ball 1624, computer vision system 30, and display 32. Although the game ball 1624 is illustrated as being spherical (such as a basketball, volleyball or soccer ball), the game ball 1624 may have other shapes, such as that of an American style football. In other implementations, the sporting object may have other forms of sporting equipment including but not limited to ball bats, rackets, paddles, helmets or other protective garments or apparel worn by a person participating in a sporting competition.

Game ball 1624 comprises an outer surface 1636 on or through which a tracked region 1640 may be sensed or detected by computer vision system 30. Tracked region 1640 is optically highlighted and optically distinguished from adjacent or nearby portions of game ball 1624 so as to be discernible from such other adjacent or nearby portions of game ball 24 by computer vision system 30. Such optical highlighting is done in a manner such that although readily discernible to computer vision system 30, tracked region 1640 is not perceptibly obvious or is largely indiscernible to the naked eye of the player or observer/fan. Region 1640 is optically highlighted by its ability to reflect particular wavelengths of light differently than that of surrounding regions of game ball 1624. Region 1640 comprises an underlying retro reflective layer 1642 and an overlying filter layer 1644.

Retro reflective layer 1642 reflects light (all wavelengths). Layer 1642 is retro in that layer 1642 reflects light back to or in the direction of the light source, in contrast to a reflective layer which may reflect light in any direction. Because layer 1642 reflects light in a controlled manner back towards the source of the light, layer 1642 reflects light towards an arena light typically supported from rafters and also towards overhead cameras, which may be located in a catwalk. As a result, layer 1642 reduces the likelihood of light being reflected in any direction, such as in a sideways direction, where the light may be reflected towards players or towards observers or fans. In some implementations, layer 1642 comprises a conventional rector reflective marker made up of tiny glass beads which reflect incoming light. In yet other implementations, retro reflective layer 1642 may have other configurations.

Filter layer 1644 overlies retro reflective layer 1642 and transmits a particular range of wavelengths while blocking or absorbing all other wavelengths. In the example illustrated, filter layer 1644 transmits infrared and near infrared wavelengths of light as well as upper regions of the visible spectrum of light. As a result, most visible light from light source 42 impinging regions about tracked region 1640 or impinging tracked region 1640 is blocked/absorbed by filter 1644, whereas a small portion of visible light that impinges region 1640 is permitted to pass through filter layer 1644 and be reflected off of retro reflective layer 1642 back towards light source 42 and towards camera 44 for capture by camera 44. This results in tracked region 1640 appearing much brighter to camera 44 than surrounding regions of game ball 1624, permitting image processor 46 (which is more sensitive than the naked eye) to optically distinguish and discern region 1640 from the remainder of game ball 1624 per tracking game ball 1624. Because filter layer 1644 blocks/absorbs a majority of the visible spectrum of light, similar to regions of game ball 1624 around tracked region 1640, tracked distinguishable by players and observers from those portions of game ball 1624 surrounding discernible to the naked eye, less discernible to players and fans/observers. Tracked region 1640 is less distinguishable from those other portions of game ball 1624 adjacent to or about tracked region 1640 by players and observers/fans.

Filter layer 1644 comprises a black solvent-based screen-printing dye configured to transmit a portion of the visible spectrum and near infrared light while blocking a majority of the visible spectrum. In one implementation, filter layer 1644 comprises a composition comprising SPECTRE™ 100 dye commercially available from EPOLIN™, characterized by its ability to absorb UV and visible light while allowing transmittance of NIR+ light. In the example illustrated, the SPECTRE™ 100 dye is diluted with the reducer (such as paint thinner) to lower the concentration of dye and shift the transition point towards the edge of the visible spectrum. The transition point is the wavelength where the filter “turns on” and begins transmitting. The dye, as is, typically transitions in the NIR+ range with 850 nm being the wavelength that transmits 70% of NIR light. The addition of the reducer thins the dye out to lower the transition point to the upper end of the visible spectrum, permitting camera 44 (a camera configured to capture images in the visible spectrum) to detect the reflected upper end of the visible spectrum from region 1640. In implementations where camera 44 is configured to sense our capture near infrared wavelengths of light or infrared wavelengths of light, filter layer 1644 may comprise a higher concentration of SPECTRE™ 100 dye or common some implementations, no reducer. In other implementations, other dyes, films, layers or composition that absorb visible light while allowing transmittance of infrared light, near infrared light and/or an upper end of the visible spectrum may be used depending upon the characteristics of camera 44 and light source 42.

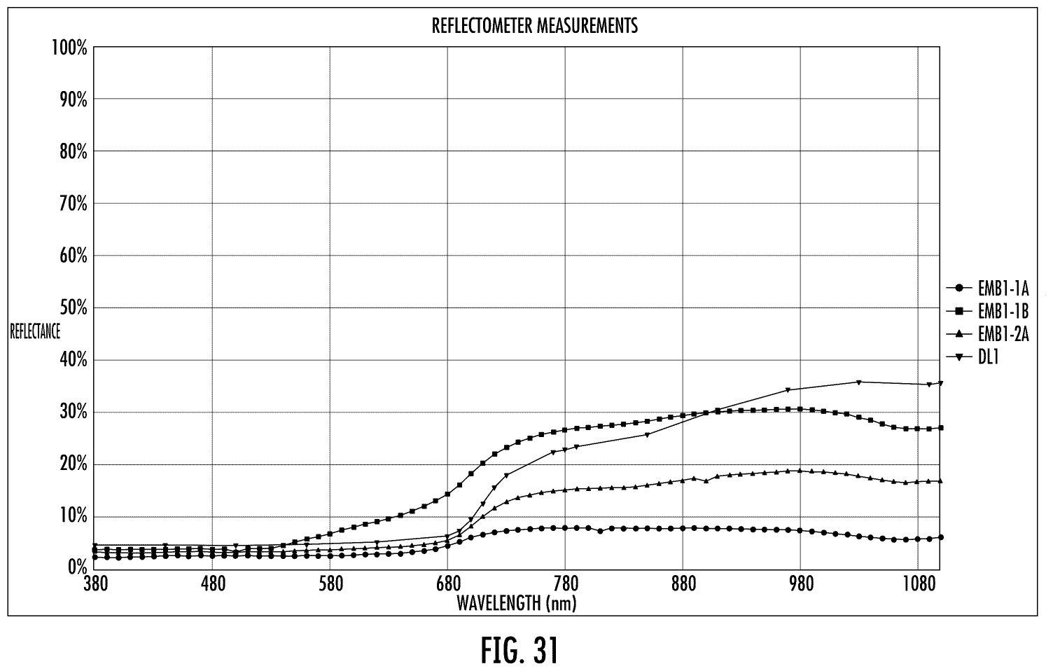

FIG. 31 is a graph indicating a reflection percentage (as detected by reflectometer) from various implementations of tracked region 1640 with respect to different wavelengths of light from a light source, such as light source 42. Line 1700 is a reflectance curve for a tracked region 1640 having a filter layer 1644 formed from a single coating having an dye to reducer ratio of 1:1. Line 1702 is a reflectance curve for a tracked region 1640 having a filter layer 1644 formed from a single coating having an dye to reducer ratio of 1:3. Line 1704 is a reflectance curve for a tracked region 1640 having a thicker filter layer 1644, a filter layer 1644 formed from two coats having an dye to reducer ratio of 1:3. As shown by FIG. 31, the filter layer according to line 1702 exhibits the highest jump in reflectivity for wavelengths of light in the upper end of the visible spectrum and beyond, providing the greatest discern ability for region 1640. The filter layer according to line 1700 exhibits a small jump in reflectivity in the upper end of the visible spectrum and beyond, being less discernible to camera 44, but also being less discernible to the naked eye of players and observers. The filter layer according to line 1704 exhibits a jump in reflectivity less than that of line 1702 (being less discernible to camera 44) but greater than that of line 1700 (being more discernible to camera 44). At the same time, tracked region 1640 with a composition according to line 1704 may be less discernible to the naked eye than a tracked region 1640 with a composition according to line 1702.

Line 1706 is a reflection curve for a tracked region formed according to the method shown in FIGS. 41A, 41B and 41C (described hereafter). As shown by FIG. 31, the tracked region represented by line 1706 has a greater rate of increase for its reflectance for wavelengths of approximately 700 nm as compared to the tracked regions represented by lines 1700 and 1704. At the higher wavelengths, the tracked region represented by line 1706 surpasses the reflectivity of the tracked region represented by line 1702. For cameras configured to capture such higher wavelengths of light, the tracked region according to line 1706 may offer even greater contrast as compared to the other tracked regions represented by the line graph.

Although schematically illustrated as a rectangle, region 1640 may have a variety of other sizes and shapes. For example, in some implementations, region 1640 may have an area having a perimeter corresponding to the perimeter of an individual panel of game ball 24 or corresponding to the perimeter or outline of a grouped set of adjacent panels of game ball 24. In some implementations, region 1640 may have an area having a perimeter wholly contained within an individual panel of game ball 1624. In some implementations, region 1640 may extend across multiple panels, having an area having a perimeter that does not correspond to a perimeter of a panel, but passes through/across a central portion of a panel. In some implementations, region 1640 may be provided along a junction of adjacent panels. In some implementations, region 1640 may be discontinuous in that region 1640 surrounds or extends about intermediate portions that are not optically enhanced, portions that may be similar to the other surrounding portions of game ball 1624. For example, region 1640 may be an annular shape, text, or open/perforate graphics/patterns, rather than a solid continuous unbroken and imperforate layer or area.

As schematically illustrated by FIG. 30, each of frames 48-1 . . . 48-n camera 44 may depict game ball 1624 at a particular location, with a particular set of coordinates x, y, z. Movement or rotation of game ball 24 also results in movement or rotation region 1640, which appears as a brighter region in each of image frames 48 due to the greater degree of reflectance by region 1640. Each of such frames 48 is streamed to image processor 46.

The instructions in medium 54 direct processing unit 52 to carry out the example method 100 outlined in FIG. 2. As indicated by block 104 in FIG. 2, image processor 46 receives images/frames 48 of game ball 1624 from camera 44. As discussed above, the depictions of game ball 1624 in images 48 include brighter regions corresponding to region 1640.

As indicated by block 108, the instructions contained in memory 54 direct processing unit 52 to identify a location of the tracked region 1640 of the game ball 1624 in each of the image frames 48. The location may comprise attributes such as a centroid of the tracked region 1640, a perimeter of the tracked region 1640, and/or the x, y, z coordinates of the tracked region in a particular coordinate system. Image processor 46 may identify the location of the tracked region 1640 by analyzing, on a pixel-by-pixel basis, the brightness of individual pixels as compared to the darkness of adjacent pixels. The boundaries between adjacent or consecutive pixels having the greatest delta or difference in brightness may be identified as the boundary/perimeter of the tracked region 1640 in the image frame. Based on the determined boundary of region 1640, a centroid of region 1640 or other reference point for region 1640 may be determined. In other implementations, image processor 46 may determine or identify the location of the game ball 1624 in each of the image frames 48 using other image processing or segmentation techniques. For example, in some implementations, machine learning (a trained machine learning or neural network) may be used by image processor 46 to identify the boundary or perimeter of each of the tracked regions 1640 on game ball 1624 in each of frames 48.

In some implementations, the x,y,z coordinates of the tracked region 1640 (or a centroid or other point of the tracked region 1640) may be determined by image processor 46 based upon the predetermined or known real-world geographical x,y,z coordinates of camera 44 and its field-of-view (and the relative positioning of game ball 1624 within the field-of-view). In some implementations, image processor 46 may determine coordinates that are in terms of relative positioning to the environment, such as relative positioning of the region 1640 (or of ball 1624) to a particular point or location in the environment 1626, on a playing field, court, target (basketball hoop/backboard) or the like, with or without reference to real-world geographical coordinates. Such coordinates may be determined based upon a known or predetermined relative positioning of the camera 44 with respect to such points or locations in the environment 26 or based upon images of the environment 26 in the frames 48 received by image processor 46. For example, the environment 26 may include optical markers indicating particular coordinate or locations, or an image processor 46 may determine the particular accordance of game ball 1624 in each image frame based upon the environmental markers also found in the image frame.

As indicated by block 112 in FIG. 2, the instructions in memory 54 direct processing unit 52 to output display signals that are based upon the identified location of the tracked region, that are based upon at least one of the real-world geographic coordinates of a centroid, movement of the location tracked region during different captured image frames, relative positioning of region 1640 or its reference points (centroid, corners, perimeter outline) with respect to the environment (field, court, target). This display signals cause display 32 to present an image or video depicting game ball 24 and the current environment 26 with one or more travel parameters TP(s) 60 and/or a superimposed image 64 (both of which are described above with respect to system 20), wherein travel primer 60 and the super was image 64 are based upon are located based upon the determined positioning of tracked region 1640.

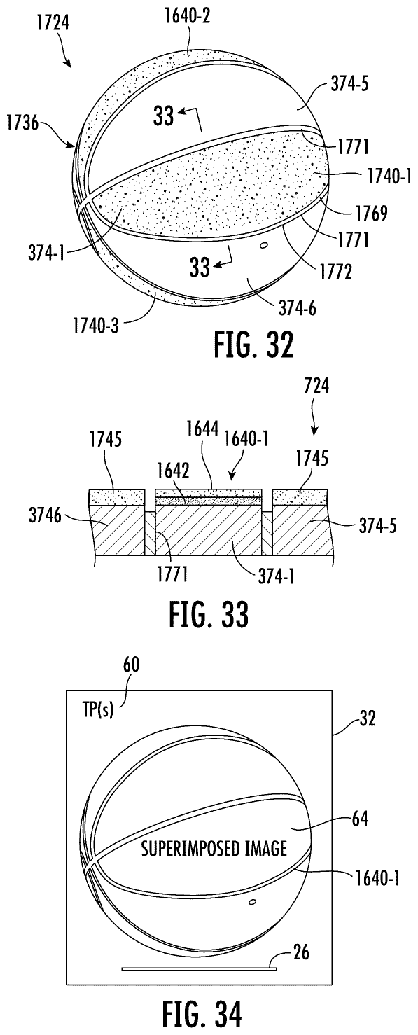

FIG. 32 illustrates an example game ball 1724, in the form of a basketball. Similar to game ball 324, game ball 1624 is formed from eight panels 374-1, 374-2, 374-3, 374-4, 374-5, 374-6, 374-7 and 374-8 (collectively referred to as panels 374). Each of such panels, when assembled to form game ball 1624, are separated by an intervening strip 1671 forming a floor of a respective channel 1672. In some implementations, panels 374 are overlaid about a carcass form from an internal inflatable bladder and windings wound about the bladder, bring strips of rubber other material positioned between the panels to form floors of the channel 372. In yet other implementations, each of the panels 374 may be part of a single integral unitary body, such as an outer body including all of the panels is molded as a single unitary piece along with the channels 1672. In some implementations, panels 374 may be formed from a polymer material, such as polyurethane. In some implementations, panels 374 may be formed from a natural or synthetic leather.

As shown by FIG. 32, game ball 1624 has an outer surface 36 comprising tracked regions 1740-1, 1740-2,1740-3, and a fourth tracked region (collectively referred to as regions 340). Each of regions 1740 is similar to tracked region 40 described above except that each of region 340 is specifically illustrated as having an outer boundary 1769 corresponding to the edges of a corresponding individual panel 374. Tracked regions 1740-1, 1740-2 and 1740-3 and their associated panels 374-1, 374-2, 374-3, respectively, are separated or spaced from one another by intervening panels 374-5 and 374-6, 374-7 (untracked, contrast panels). The alternating tracked regions 340 and untracked panels 374 have sufficient contrast to enhance tracking of the rotation of game ball 1724 by camera 44 and image processor 46 described above.

In other implementations, game ball 1724 may be formed from differently shaped panels or a different number of panels. In some implementations, one or more of regions 340 may have an area having a perimeter wholly contained within their respective individual panels 374 of game ball 1724. In some implementations, regions 1740 may have a perimeter that corresponds to the perimeter of a set or group of consecutive panels 374. For example, in some implementations, game ball 1724 may comprise two tracked regions 1740 instead of four, such as where a first tracked region has an area and perimeter corresponding to the area and perimeter of an outline of both of panels 374-1, 374-6, wherein a second tracked region has an area perimeter corresponding to the area and perimeter of an outline of both of panels 374-4 and 374-8 (shown in FIG. 4) and wherein the remaining panels 374 are not associated with a tracked region.

In some implementations, one or more of regions 1740 may extend across multiple panels 374, having an area having a perimeter that does not correspond to a perimeter of a panel 374, but passes through a central portion of a panel 374. In some implementations, regions 1740 may be provided along a junction of adjacent panels, such as along channels 1772. In some implementations, one or more of regions 1740 may be discontinuous in that a particular region 1740 surrounds or extends about intermediate portions that are not optically enhanced, portions that may be similar to the other untracked panels 374-5 to 374-8. For example, one or more region 1740 may be an annular shape, text, or open/perforate graphics/patterns, rather than a solid continuous unbroken and imperforate layer or area.

FIG. 33 is a sectional view schematically illustrating a portion of game ball 1724 taken along line 33-33 of FIG. 32. For purposes of illustration, FIG. 33 omits additional layers of game ball 1724. For example, as discussed above, in some implementations, game ball 1724 may additionally comprise a carcass formed by a bladder and windings about the bladder, wherein the illustrated construction overlies the carcass. In some implementations, such windings may be omitted. In some implementations, the construction shown in FIG. 33 is integrally formed as part of a single unitary body, such as a single molded unitary body. In some implementations, one or more additional coatings or films may be applied over an exterior of the illustrated construction to provide a more uniform feel. Such coatings or films may be transparent so as to not interfere with absorption and reflection of light. In some implementations, those panels associated with tracked regions may be differently coated or covered then those panels not associated with tracked regions to assist making panels associated with tracked regions and panels not associated with tracked regions less discernible from one another. For example, panels 374-5 and 375-6 may have an additional outer coating or film having different optical properties than a coating applied over panel 374-1 with his tracked region 1740-1. The different coatings may offer a more uniform touch or feel across all of panels 374, while obfuscating any perceivable visible differences between panels 374.

As shown by FIG. 33, tracked region 1740-1 is formed on panel 374-1. As discussed above, tracked region 640-1 comprises an underlying retro reflective layer 1642 and an overlying filter layer 1644 (both of which are described above). In the example illustrated, the nearby or adjacent panels 374-5 and 374-6 are each provided with an additional outer layer 1745 having a thickness similar to the combined thickness of layers 1642 and 1644 and tactile properties similar to that of filter layer 1644. As a result, the exterior of panels 374-5 and 374-6 are substantially physically imperceptible from panel 374-1 and tracked region 1740-1. In some implementations, layers 1745 comprise a thicker (more coats) of layer 1644 without the underlying retro reflective layer 1642. In other implementations, layer 1645 may be omitted.

FIG. 34 illustrates display 32 (as part of system 20 with game ball 324 replacing game ball 24) presenting an individual image frame of a stream of image frames (a video) depicting game ball 1724 in its associate environment 26 (described above). As shown by FIG. 34, image processor 46 may carry out method 100 described above. In the example illustrated, image processor 46 output display signals causing display 32 to present travel parameters 60 (described above and an example superimposed image 64 (described above on top of the tracked region 1740-1.

Although tracked regions 1740 are illustrated completely filling the panels upon which the tracked region 1740 are provided, in other implementations, may be inset from the boundaries of the panels (similar to tracked regions 840-2 and 840-3 described above. Although tracked region 1740 are illustrated as being provided on the example game ball 1724, which is in the form of a basketball, tracked region 1740 may likewise be provided on other game balls such as game ball 924 in place of tracked regions 940 or game ball 1024 in place of tracked regions 1040. Tracked region 1740 may also be divided on game ball 1124 in place of tracked region 1140 or on game ball 1224 in place of tracked regions 1240.

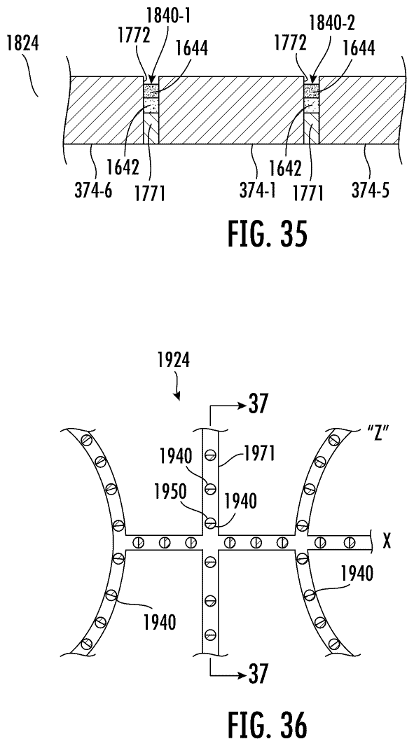

FIG. 35 is a sectional view illustrating portions of an example game ball 1824 for use as part of system 1620 in place of game ball 1624. Game ball 1824 is similar to game ball 1724 described above except that game ball 1824 omits tracked region 1640-1 and layers 1745 alternatively comprises tracked regions 1840-1 and 1840-2 within the channels 1772 and on top of strips 1771. As with tracked region 1640, each of tracked regions 1840-1 comprises an underlying retro reflective layer 1642 and an overlying filter layer 1644, both of which are described above. Tracked regions 1840 have enhanced reflective properties for particular wavelengths of light such that regions 1840 appear brighter in the images of game ball 1824 captured by camera 44, permitting the location of regions 1840 to be identified for tracking game ball 1824.

In some implementations, one or both of regions 1840 may be tracked by image processor 46 such that image processor 46 may determine and present one or more travel parameters 60. In some implementations, tracked regions 1840 may be used as an outline for a region or surface on game ball 1824 upon which image processor 46 is to superimpose image 64 (between the brighter lines in the image frames defined by regions 1840). For example, regions 1840 may outline an area of panel 374-1, wherein image processor 46 superimposes image 64 on panel 374-1 during movement of game ball 1824 as depicted in a video.

FIGS. 36, 37, and 38 illustrate portions of an example game ball 1924, shown as an example basketball, for use as part of system 1620 (or system 20). Game ball 1924 is similar to game ball 1824 in that game ball 1924 comprises optically highlighted channels 1971 which serve as tracked markers or regions 1940. Regions 1940 extend along and within channels 1971. Regions 1940 provide an optical contrast with respect to the surrounding panels, wherein the optical contrast is perceptible by camera 44 of system 1620, but substantially imperceptible or less perceptible to the naked eye of a player or a local observer/fan.

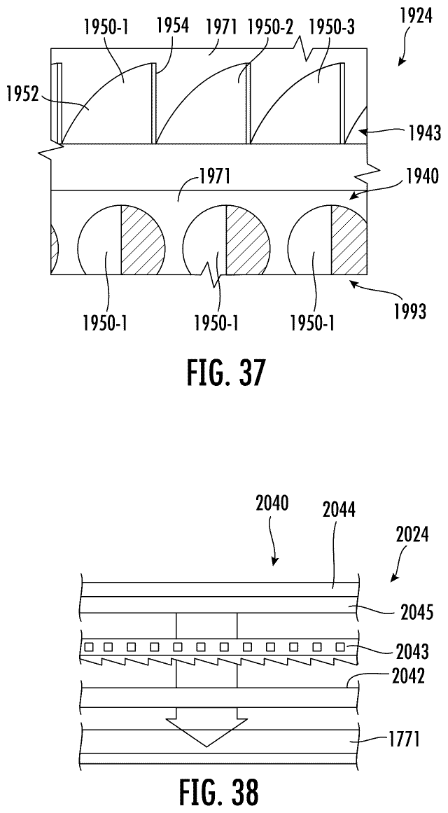

FIG. 37 is a sectional view of tracked region 1940 along a portion of one of channels 1971 including a view of tracked region 1940 a portion of one of channels 1971. Tracked region 1940 comprises a series of teeth 1950-1, 1950s-2, 1950-3 (collectively referred to as teeth 1950. Each of teeth 1950 comprises a substantially nonreflective back face 1952 and a reflective vertical face 1954. Each of teeth 1950 provides controlled reflection in a designated direction, such as towards the light source and towards camera 44 to reduce the discern ability of region 1940 by players or local observer/fans.

FIG. 38 illustrates portions of an alternative tracked region 2040 for game ball 1924. As shown by FIG. 38, tracked region 2040 comprise a reflective film 2042, lenticular view blocker 2043, NIR+ absorbing dye 2044 and transparent layer 2045. Reflective film 2042 extends over and on top of the base layer provided by strip 1771. Reflective film 2042 need not necessarily be retroreflective. Lenticular view blocker 2043 extends over reflective film 2042 and is covered by transparent layer 2045. An NIR+ absorbing dye covers her coats transparent layer 2045. The NIR+ absorbing dye may comprise Spectre 100.

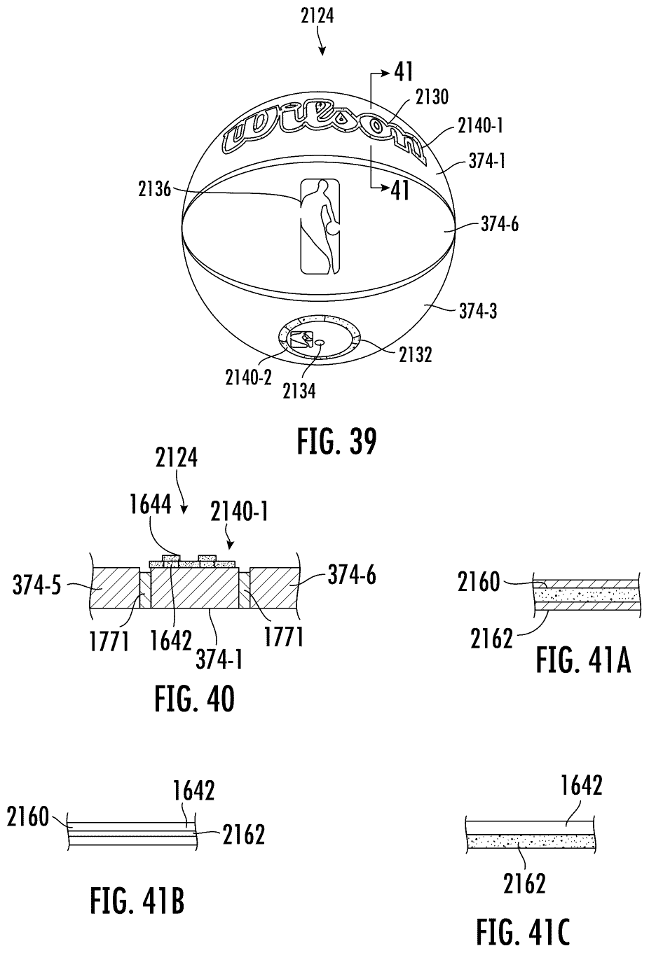

FIG. 39 illustrates an example game ball 2124 in the form of an example basketball. FIG. 39 illustrates other configurations and locations for a tracked region on a game ball, such as the illustrated example basketball. Game ball 2124 may have a configuration similar to game balls 324 and 624 described above. As with game balls 324 and 1624, game ball 2124 may comprise panels situated about a carcass that comprise an inflatable bladder and windings or may be integrally molded as a single unitary body with or without bladder. In some implementations, the panels of game ball 2124 may be a polymeric material such as a polyurethane. Still other implementations, the panels may be formed from a synthetic leather or natural leather.

Similar to game balls 24, 324 and 724, game ball 2124 comprises panels 374. Panel 374-1 comprises a printed logo 2130 (WILSON™), panel 374-3 comprises valve art 2132 situated about a valve 2134. Panel 374-6 comprises an NBA logoman silhouette 2136. In the example illustrated, tracked regions 2140-1 and 2140-2 are formed on panel 374-1 and 374-3 about or along logo 2130 and artwork 2132. In particular, tracked region 2140-1 outlines logo 2130. Tracked region 2140-2 encircles the valve and is incorporated as part of the graphics or text of the artwork.

FIG. 40 is a sectional view schematically illustrating tracked region 2140-1. Tracked region 2141 comprises reflective layer 1642 which underlies NIR+ filter layer 1644, both of which are described above. Tracked region 2140-2 is similarly formed from a line or pattern of a retroreflective layer 1642 underlying the correspondingly shaped and patterned NIR+ filter layer 1644.

FIGS. 41A, 41B, and 41C schematically illustrate one example method for forming or applying a tracked region, such as tracked region 340-1, to a game ball, such as the above-described basketballs. As shown by FIG. 41A, adhesive 2160 is applied to screen print paper 2158 to match the outline of logo 2130. As shown by FIGS. 41B and 41C, a retroreflective layer or film 1642 (with a polyethylene terephthalate (PET) backing) is placed directly on the adhesive 2160, wherein a chemical wash is used to remove the PET backing and unwanted logo areas as shown in FIG. 41C. Thereafter, the logo outline is applied using a high RF screenprint stamping machine. Once this is done, the filter layer 1644 is applied on top of the retroreflective layer 1642, such as by screen printing.

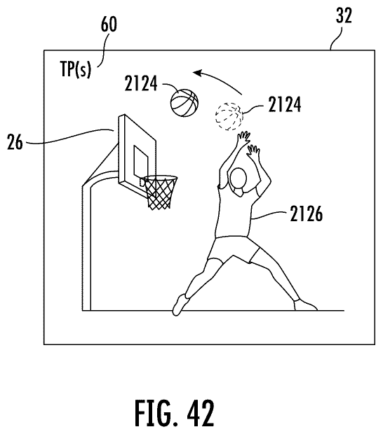

FIG. 42 illustrates display 32 (as part of system 1620 with game ball 2124 replacing game ball 1624) presenting an individual image frame of a stream of image frames (a video) depicting game ball 2124 in its associated environment 26 (described above). As shown by FIG. 42, image processor 46 may carry out method 100 described above. In the example illustrated, image processor 46 output display signals causing display 32 to present travel parameters 60 of ball 2124 in-flight during a shot. As discussed above, the travel parameters 60 are based upon tracking of ball 2124 by image processor 46 using the optically highlighted tracked regions 2140. In some implementations, additional tracked regions may be provided on ball 2124. For example, the logo 2136 may be outlined or may incorporate the above-described retroreflective layer 1642 and overlying filter layer 1644. In the example illustrated, the travel parameters 60 are concurrently presented on the same image depicting the player 2126 and the ball 2124. In other implementations, travel parameters 60 may be separately communicated or displayed.

In at least some of the above examples, a NIR+ absorbing layer or in NIR+ filter layer is utilized to control what particular wavelengths of light are received or captured by camera 44 to allow imaging processor 46 to discern between tracked regions and untracked regions. In the examples shown and described above with respect to FIGS. 1-30, a small upper portion of the visible spectrum is absorbed such that a tracked region appears darker in the images captured by a camera configured to capture images in the visible spectrum. In the examples shown and described above with respect to FIGS. 31-42, a small upper portion of the visible spectrum is transmitted and reflected such that a tracked region appears brighter in the images captured by a camera configured to capture images in the visible spectrum. In each of such examples, the absorbing layer or the filtering layer may alternatively operate in different wavelengths (different wavelengths ranges) in accordance with the capabilities of the camera 44. For example, when such systems utilize a camera configured to capture light in the near infrared or infrared spectrums, the absorbing layer may be configured to simply absorb light in the near infrared spectrum or in the infrared spectrum. Alternatively, the filter layer may be configured to transmit and reflect light in just the near infrared spectrum or the infrared spectrum. In each of the above-described implementations, a bandpass filter or filter layer may be utilized in place of the described NIR+ filter layer.

In some implementations, the near infrared absorbing material or the filter layer described above may be replaced with a wave plate which polarizes light in just the tracked regions, wherein a polarizing filter may be placed in front of the camera or incorporate part of the camera such that only the camera captures reflected light from the tracked region (when the polarization types or directions of the wave plate and the polarizing filter of the same) or such that only the camera does not capture reflected light from the tracked region (when the polarization types or directions of the wave plate in the polarizing filter are different, such as being angularly offset 90°), permitting image processor to distinguish and identify the tracked region on game ball or other piece of sporting equipment for generating and displaying travel parameters and/or for superimposing an image on a particular predefined region of the game ball or other sporting equipment.

Although the present disclosure has been described with reference to example implementations, workers skilled in the art will recognize settings the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A game ball for an optical tracking system, the game ball comprising:
a tracked region on the game ball, the tracked region comprising:
a retro reflective surface; and
an optical filter overlying the retro reflective surface.

2. The game ball of claim 1, wherein the optical filter has a cut on of a wavelength of at least 600 nm.

3. The game ball of claim 1, wherein the optical filter has a cut on of a wavelength of at least 700 nm.

4. The game ball of claim 1, wherein the optical filter has a cut on of a wavelength of at least 780 nm.

5. The game ball of claim 1 where the optical filter comprises an dye applied on the retro reflective surface.

6. The game ball of claim 1, wherein the game ball comprises a basketball having channels and wherein the tracked region is disposed within a portion of at least one of the channels.

7. The game ball of claim 1, wherein the game ball comprises a surface markings or logo and wherein the tracked region outlines the perimeter edge of the marking or logo.

8. The game ball of claim 1, wherein the game ball comprises a valve region, wherein the tracked region is located proximate the valve region.

9. The game ball of claim 1, wherein the game ball comprises a black colored surface region and wherein the tracked region overlies the black colored surface region.

10. The game ball of claim 1, wherein the tracked region further comprises a lenticular channel overlying the reflective surface.

11. An optical marker for application to a game ball, the optical marker comprising:
a retro reflective layer; and
an optical filter overlying the retro reflective layer.

12. The optical of claim 12 further comprising an adhesive layer underlying the retroreflective layer.

13. The optical marker of claim 12, wherein the retro reflective layer and the optical filter each have a width less than a width of a basketball exterior channel.

14. The optical marker of claim 12, wherein the retro reflective layer and the optical filter form a panel having a perimeter outlining a logo.

15. The optical marker of claim 12, wherein the optical filter has a cut on of a wavelength of at least 600 nm.

16. The optical marker of claim 12, wherein the optical filter has a cut on of a wavelength of at least 700 nm.

17. The optical marker of claim 12, wherein the optical filter has a cut on of a wavelength of at least 780 nm.

18. The optical marker of claim 12 where the optical filter comprises an dye applied on the retro reflective layer.

19. A method comprising:
capturing images of a game ball having a retroreflective layer underlying an optical filter;
identifying a tracked region on the game ball in each of the images based on light reflected from the retroreflective layer;
tracking movement of the tracked region during movement of the game ball; and
displaying a travel parameter of the game ball based on the tracked movement of the tracked region.

20. The method of claim 20, wherein the game ball comprises a basketball and wherein the method further comprises determining a player to last touch the basketball based on changes in the travel parameter.
